(19) United States
(12) Patent Application Publication
(10) Pub. No.: US 2024/0300698 A1
(43) Pub. Date: Sep. 12, 2024

(54) CUSHION SHEET PRODUCTION MODULE AND PRODUCTION METHOD, PACKAGING BAG PRODUCTION DEVICE AND PRODUCTION MEHOD THEREOF

(71) Applicants: BETA (SHENZHEN) PACKAGE PRODUCTS CO., LTD, Shenzhen (CN); HUIZHOU BETA PACKTECH CO., LTD, Huizhou (CN)

(72) Inventor: Jinwei Yan, Shenzhen (CN)

(21) Appl. No.: 18/666,334

(22) Filed: May 16, 2024

Related U.S. Application Data
(63) Continuation-in-part of application No. 18/208,908, filed on Jun. 13, 2023, now Pat. No. 12,017,820.
Application No. 18/208,908 is a continuation-in-part of application No. 17/223,029, filed on Apr. 6, 2021, now Pat. No. 11,731,808.
Application No. 17/223,029 is a continuation-in-part of application No. 16/878,645, filed on May 20, 2020, now abandoned.
Application No. 16/878,645 is a division of application No. 16/795,554, filed on Feb. 19, 2020, now Pat. No. 10,850,891.
Application No. 17/223,029 is a continuation-in-part of application No. PCT/CN2019/121161, filed on Nov. 27, 2019.
Application No. PCT/CN2019/121161 is a continuation-in-part of application No. PCT/CN2019/110740, filed on Oct. 12, 2019.
Application No. PCT/CN2019/110740 is a continuation-in-part of application No. PCT/CN2019/090469, filed on Jun. 10, 2019.

(30) Foreign Application Priority Data
Mar. 29, 2019 (CN) 201910252856.0
Mar. 29, 2019 (CN) 201920419356.7
Aug. 8, 2019 (CN) 201910731634.7
Mar. 3, 2021 (CN) 202110237367.5
Aug. 22, 2022 (CN) 202211009671.5
Sep. 8, 2023 (CN) 202311164505.7

(51) Int. Cl. B65D 30/08; B31B 70/00; B31B 70/02; B31B 70/14; B31B 70/16; B31B 70/20; B31B 70/26; B31B 70/62; B31D 5/00; B32B 1/00; B32B 3/26; B32B 29/00; B65D 65/40; B65D 65/46; B65D 81/02; B65D 81/03

(52) U.S. Cl. CPC B65D 31/02; B31B 70/005; B31B 70/02; B31B 70/024; B31B 70/142; B31B 70/16; B31B 70/20; B31B 70/26; B31B 70/62; B31D 5/0065; B32B 1/00; B32B 3/266; B32B 29/005; B65D 65/406; B65D 65/44; B65D 65/466; B65D 81/03; B32B 2439/06

(57) ABSTRACT

The present disclosure provides a cushion sheet production module configured to synchronously and continuously feed first and second surfaces, roll to apply a plurality of first horizontal glues on the first and second surfaces along a direction perpendicular to a feeding direction, the plurality of first horizontal glues arranged at intervals between each other, and continuously apply first longitudinal glues on both sides of the first surface or the second surface facing each other; and then, the first and second surfaces are pressed together to fix with each other at positions of the first horizontal and longitudinal glues, to form a cushion sheet, wherein gas is sealed between the first and second surfaces; or, a buffer layer added between the first and second surfaces to fix the first and second surfaces and the buffer layer together at the first horizontal and longitudinal glues, to form the cushion sheet.

### 1. CROSS-REFERENCE TO RELATED APPLICATIONS

This application is a continuation-in-part of U.S. application Ser. No. 18/208,908, filed on Jun. 13, 2023, which is a continuation-in-part of U.S. application Ser. No. 17/223,029, filed on Apr. 6, 2021, which is a continuation-in-part of U.S. application Ser. No. 16/878,645, filed on May 20, 2020, which is a division of U.S. application Ser. No. 16/795,554, filed on Feb. 19, 2020. U.S. application Ser. No. 17/223,029, filed on Apr. 6, 2021, is a continuation-in-part of International Application No. PCT/CN2019/121161, filed on Nov. 27, 2019, and is a continuation-in-part of International Application No. PCT/CN2019/110740, filed on Oct. 12, 2019, and is a continuation-in-part of International Application No. PCT/CN2019/090469, filed on Jun. 10, 2019. This application claims priority to Chinese Application No. 202211009671.5, filed on Aug. 22, 2022, Chinese Application No. 202110237367.5, filed on Mar. 3, 2021, Chinese Application No. 201910731634.7, filed on Aug. 8, 2019, Chinese Application No. 201920419356.7, filed on Mar. 29, 2019, and Chinese Application No. 201910252856.0, filed on Mar. 29, 2019, Chinese Application No. 202311164505.7, filed on Sep. 8, 2023. The entire contents of all of the above-identified patent applications are incorporated herein by reference.

### BACKGROUND

### 2. Technical Field

The present disclosure generally relates to the field of packaging applied to express deliveries, and especially relates to a cushion sheet production module, a packaging bag production device and a production method thereof.

### 3. Description of Related Art

A common packaging bag with a buffering function is an air bubble bag, which is formed by folding a bottom side and sealing a side of an air bubble sheet. The air bubble sheet is a sheet-like structure as a whole and composed of a plurality of arrays of air bubbles arranged on an inner surface of a plastic film, the plurality of air bubbles formed by the plastic film. Such type of packaging bag is commonly used in express deliveries for packaging electronic products, with good buffering effect thereof. However, such type of packaging bag is made of plastic products, which is not environmentally friendly and difficult to be degraded, and with a demand for plastic degradation, it will gradually be phased out in the market.

A full-paper cushion packaging bag is the most effective and environmentally friendly packaging bag, which can completely replace the air bubble bag in terms of buffering performances, raw material supplies and environmental conveniences.

A conventional full-paper cushion packaging bag is also made of the cushion sheet. Specifically, the cushion sheet is a strip structure, and delivered step by step along a length direction on a device. The cushion sheet includes a first surface, a second surface, and at least one layer of cushion sheet with a three-dimensional grid arranged between the first surface and the second surface, wherein the first surface, the second surface and the cushion sheet are all made of paper material. During producing the cushion sheet, the first surface, the second surface and the cushion sheet are all delivered step by step. On a workbench of the equipment, the first surface, the cushion sheet and the second surface are stacked up and down in sequence to be delivered. For every delivery, it is necessary to spray glue on gluing positions of inner and outer surfaces of the first and second surfaces that are perpendicular to the feeding direction. At a rear end of spraying glue, positions of spraying glue that are overlapped are pressed together to fix the first surface, the second surface and the cushion sheet. At this time, for the cushion sheet with the strip structure, the first surface, the second surface and the cushion sheet, are all spaced apart and fixed together at the positions of spraying glue perpendicular to the feeding direction.

When producing the packaging bag by using the above-mentioned cushion sheet with the strip structure, it is necessary to use a folding structure to fold the cushion sheet to form a bottom side of a bag body of the packaging bag, and a folding line during folding the cushion sheet is a line near a centerline of the cushion sheet with the strip structure along a length direction thereof. During a folding process, the cushion sheet with the strip structure is still delivered in a step-by-step manner. After the cushion sheet is folded, adhesive positions of spraying glue on an outer side of the first surface, which is an upper surface of the strip sheet, are overlapped. After pressing again, the adhesive positions are fixed as side edges of the packaging bag. Two adjacent adhesive positions respectively form two sides of the packaging bag, in this way, a receiving depth of the packaging bag is only half of that of the original cushion sheet with the strip structure. After the cushion sheet with the strip structure is folded to form the packaging bag, because a plurality of packaging bags are connected on sides of the packaging bags in sequence, which is to still form the strip structure, in this way, the sides of spraying glue that are connected together are then cut to form the plurality of independent packaging bags. A fixed width on the side of each packaging bag is only half of that of an original width of spraying glue. There are many shortcomings by using the above method to produce the packaging bag, specifically, there are the following technical problems:
firstly, a speed is relatively slow. In the conventional production process of buffer packaging bags, due to the use of a step-by-step method, it is necessary to wait a time for spraying glue, a pressing time and a cutting time after the cushion sheet is delivered step-by-step. Only after positions of spraying glue, pressing and cutting are completed, a next delivery step by step can be performed, thereby resulting in lower production efficiency.
secondly, when producing a packaging bag by using the strip cushion sheet, it is necessary to fold the strip cushion sheet, and the depth of the folded packaging bag is only half of that of the original cushion sheet, which is not conducive to producing large-sized packaging bags.
thirdly, a bottom of the packaging bag is formed by the folded cushion sheet, is not fixed by spraying glue and has an insufficient fixing strength, which may cause damage and cracking of the packaging bag.

### SUMMARY

The technical problems to be solved: in view of the shortcomings of the related art, the present disclosure provides a cushion sheet production method which can solve problems that a slow production speed is occurred by using a conventional production method in the related art above mentioned.

A cushion sheet includes a first surface and a second surface.

A cushion sheet production method according to an embodiment of the present disclosure includes:
step S1, unreeling or feeding the first surface and the second surface, both a first horizontal glue and a first longitudinal glue applied on at least one of the first surface and the second surface, the first horizontal glue and the first longitudinal glue arranged on a surface of the first surface and/or the second surface that faces the other first surface or the other second surface; the first horizontal glue perpendicular to a feeding direction and arranged at intervals along the feeding direction, with the same spacing distance thereof; the first longitudinal glue continuously arranged along edges on both sides of the feeding direction; the first surface and the second surface stacked up and down and arranged on a machine, and synchronously and continuously fed; and wherein
when both the first horizontal glue and the first longitudinal glue are applied on both the first surface and the second surface, the first horizontal glue on the first surface corresponding to the first horizontal glue on the second surface after the first horizontal glue on the first surface is continuously fed, and the first longitudinal glue on the first surface corresponding to the first longitudinal glue on the second surface after the first longitudinal glue on the first surface is continuously fed;
step S2, rolling and pressing the first surface and the second surface that are stacked with each other after applying the first horizontal glue and the first longitudinal glue, with pressing positions only being located at the first horizontal glue and the first longitudinal glue, fixing the first and second surfaces to each other at positions of the first horizontal glue, and fixing the first and second surfaces to each other at positions of the first longitudinal glue to form the cushion sheet; and wherein
the cushion sheet is sealed with gas between positions of the first horizontal glue and positions of the first longitudinal glue to provide a buffering effect thereof.

In the method of the present disclosure, a buffer layer can also be added between the first surface and the second surface, which has buffering performance. In the method of the present disclosure, both the first surface and the second surface, or all the first surface, the second surface and the buffer layer, adopt a continuous feeding mode, that is, throughout the feeding process, the first surface, the buffer layer and the second surface are all in a continuous motion state, rather than a stopping state. In the continuous feeding process, by performing rolling glue on the first surface, the buffer layer and the second surface when applying the first horizontal glue to the first surface, the buffer layer and the second surface. When applying the first longitudinal glue to the first surface and/or the second surface, or the buffer layer, performing continuous glue is adopted on the first surface and/or the second surface, or the buffer layer, such as spraying glue or coating glue, such sizing glue method can cooperate with the continuous feeding process to achieve sizing glue without stopping the feeding to wait. Compared with a step-by-step feeding method of waiting for sizing glue during the interval between two step times, the above method of the present disclosure greatly improves production efficiency; in addition, when pressing the first surface, the second surface and the buffer layer, a rolling-pressing method is also used to ensure a smooth continuous feeding to the front end.

A packaging bag production method according to an embodiment of the present disclosure includes:
step D1, producing two pieces of cushion sheets by the cushion sheet production method as mentioned above, the two pieces of cushion sheets comprising a first cushion sheet and a second cushion sheet stacked with each other, and the second cushion sheet arranged below the first cushion sheet; after the first cushion sheet and the second cushion sheet are stacked, the position of the first horizontal glue of the first cushion sheet corresponding to the position of the first horizontal glue of the second cushion sheet, and the position of the first longitudinal glue of the first cushion sheet corresponding to the position of the first longitudinal glue of the second cushion sheet; and wherein when the first cushion sheet and the second cushion sheet are produced, or after the first cushion sheet and the second cushion sheet are produced and before the first cushion sheet and the second cushion sheet are stacked with each other, a position of a second horizontal glue is applied on at least one surface of the first cushion sheet or the second cushion sheet facing each other, and a position of a second longitudinal glue is applied on at least one surface of the first cushion sheet or the second cushion sheet facing each other; the position of the second longitudinal glue only located on an edge of the first cushion sheet or the second cushion sheet along the feeding direction, and the position of the second horizontal glue perpendicular to the feeding direction and arranged at intervals along the feeding direction, with the same spacing distance thereof; the first cushion sheet and the second cushion sheet that are stacked so that the position of the second horizontal glue is opposite to the position of the first horizontal glue, and the position of the second longitudinal glue is opposite to the position of the first longitudinal glue on a side thereof; and
step D2, synchronously feeding the first cushion sheet and the second cushion sheet that are stacked, and rolling and pressing the first cushion sheet and the second cushion sheet in a stacked state, so that the first cushion sheet and the second cushion sheet are fixed with each other at the positions of the second horizontal glue and the positions of the second longitudinal glue, to form a packaging bag with two fixed sides thereof.

In the packaging bag production method of the present disclosure, the first cushion sheet and the second cushion sheet are stacked and continuously fed, during the production process that the first and second cushion sheets are continuously fed, the second horizontal glue is set on at least one surface of the first cushion sheet and the second cushion sheet facing each other to form the position of the second horizontal glue, the second longitudinal glue set to form the position of the second longitudinal glue, and then, the first and second cushion sheets are rolled and pressed at the positions of the second horizontal glue and the position of the second longitudinal glue to fix the first and second cushion sheets, for forming the packaging bag. The position of the second longitudinal glue is only located on one edge of the first cushion sheet or the second cushion sheet along the feeding direction, and no glue is applied on the other edge of the first cushion sheet or the second cushion sheet along the feeding direction, thereby naturally forming an opening of the packaging bag.

In the packaging bag production method of the present disclosure, the first and second cushion sheets that are continuously fed can match with the first surface, the second surface and the buffer layer that are used to produce the cushion sheets, which can save equipment spaces and reduce process difficulties, that is, the first and second cushion sheets can be made separately at the front end of the same device, and the first and second cushion sheets can be glued and rolled at the back end of the device to produce packaging bags, in this way, the entire device adopts the same continuous feeding mode, and feeding speeds are the same at the front and back ends, which can produce the packaging bags most conveniently.

In addition, a depth of the packaging bag produced by the method of the present disclosure is basically equal to the width of the first cushion sheet or the second cushion sheet perpendicular to the feeding direction. Compared to conventional technologies, it is necessary to fold the cushion sheet and gradually feed the cushion sheet during the folding process, which is conducive to producing packaging bags with larger depths and having higher production efficiency thereof.

In the conventional method of producing packaging bags by folding cushion sheets, the bottom of the packaging bag is formed by the folded cushion sheet itself without sizing glue to fix, so that a fixing strength is insufficient. The packaging bag produced by the method of the present disclosure is formed by adhesive bonding the first and second cushion sheets at the positions of the second longitudinal glue to form the bottom of the packaging bag, which can improve the fixing strength of the bottom of the packaging bag through the adhesive bonding way.

A packaging bag production method according to another embodiment of the present disclosure includes:
step A1, producing two pieces of cushion sheets by the above method, the two pieces of cushion sheets comprising a first cushion sheet and a second cushion sheet, the second cushion sheet arranged below the first cushion sheet; a width of the first cushion sheet perpendicular to the feeding direction smaller than a width of the second cushion sheet perpendicular to the feeding direction, both sides at the width of the second cushion sheet extending out of the first cushion sheet to form a first edge and a second edge, the first cushion sheet and the second cushion sheet stacked with each other and continuously fed; and wherein
after the first cushion sheet and the second cushion sheet are stacked, the position of the first horizontal glue of the first cushion sheet corresponds to the position of the first horizontal glue of the second cushion sheet, and the position of the first longitudinal glue of the second cushion sheet is located outside the position of the first longitudinal glue of the first cushion sheet; and wherein when the first cushion sheet and the second cushion sheet are produced, or after the first cushion sheet and the second cushion sheet are produced and before the first cushion sheet and the second cushion sheet are stacked with each other, a position of a second horizontal glue is applied on at least one surface of the first cushion sheet or the second cushion sheet facing each other, and a position of a second longitudinal glue is applied on a surface of the second cushion sheet facing the first cushion sheet; a position of the second longitudinal glue only located on the first edge or the second edge of the second cushion sheet along the feeding direction, wherein the first cushion sheet and the second cushion sheet are stacked so that the position of the second horizontal glue is opposite to the position of the first horizontal glue;
step A2, synchronously feeding the first cushion sheet and the second cushion sheet that are stacked, and rolling and pressing the first cushion sheet and the second cushion sheet in a stacked state, so that the first cushion sheet and the second cushion sheet are fixed with each other at the position of the second horizontal glue; and
step A3, synchronously feeding the first cushion sheet and the second cushion sheet that are stacked, folding the first edge or the second edge of the second cushion sheet with the position of the second longitudinal glue towards a side of the first cushion sheet, rolling and pressing the first edge or the second edge after folding the first edge or the second edge, so that the first cushion sheet and the second cushion sheet are fixed with each other at the position of the second longitudinal glue, to form a packaging bag thereof.

In the packaging bag production method of the present disclosure, the two cushion sheets that are produced have different widths, where the width of the second cushion sheet located above is smaller than the width of the first cushion sheet located below, and both sides of the width of the second cushion sheet extend out of the first cushion sheet, to form the first edge and the second edge. The second longitudinal glue is applied on the first edge or the second edge to form the position of the second longitudinal glue, the first edge or the second edge that is applied the second longitudinal glue is folded towards the first cushion sheet, to bond the position of the second longitudinal glue onto the first cushion sheet to form the bottom of the packaging bag. In the method, the packaging bags made of the first and second cushion sheets reduce the width of the first and second cushion sheets that are directly pressed at the position of the first horizontal glue compared to the packaging bags made by the previous packaging bag production method, so that a greater depth of the packaging bag made by the method can be obtained.

A cushion sheet production module according to an embodiment of the present disclosure that a cushion sheet includes a first surface and a second surface,
the cushion sheet production module includes:
a first unreeling unit arranged on a machine and configured to perform unreeling on the first surface and continuously feed the first surface along a length direction of the machine;
a second unreeling unit arranged on the machine and configured to perform unreeling on the second surface and continuously and synchronously feed the second surface with the first surface along the length direction of the machine, and the second surface arranged below the first surface; a first horizontal glue applied at intervals along a direction perpendicular to the feeding direction and applied on a surface of one of the first surface and/or the second surface facing the other of the first surface or the second surface; on the surface of the first surface and/or the second surface facing the other first surface or the other second surface, a first longitudinal glue continuously applied along edges of both sides of a feeding direction; a position of the first horizontal glue of the first surface opposite to a position of the first horizontal glue of the second surface during the feeding process, and a position of the first longitudinal glue of the first surface opposite to a position of the first longitudinal glue of the second surface during the feeding process; and
a paper pressing unit configured to rolling and clamping the position of the first horizontal glue and the position of the first longitudinal glue that are arranged on the first surface and/or the second surface, to press and fix the first and second surfaces at positions of the first horizontal glue and positions of the first longitudinal glue, to form the cushion sheet, wherein gas is sealed between the first surface and the second surface to provide a buffering effect for the cushion sheet.

In the cushion sheet production module, it is also possible to produce cushion sheets with a buffer layer, and the buffer layer sandwiched between the first surface and the second surface.

The cushion sheet production module of the present disclosure adopts a continuous feeding mode to feed the first and second surfaces, as well as the buffer layer formed by stretching the third surface, and applies the first horizontal glue and the first longitudinal glue to the first and second surfaces, and the buffer layers respectively during the feeding process, or the first and second surfaces, and the buffer layers already have set the first horizontal glue and the first longitudinal glue, and then the first surface, the second surface and the buffer layers are rolled and pressed during the feeding process to produce the cushion sheet. Compared to conventional cushion sheet production modules without using a step-by-step feeding method, the cushion sheet production module of the present disclosure can improve production efficiency thereof.

A packaging bag production device according to an embodiment of the present disclosure includes:
two cushion sheet production modules, one of the two cushion sheet production modules configured to produce a first cushion sheet and the other of the two cushion sheet production modules configured to produce a second cushion sheet, the first cushion sheet arranged above the second cushion sheet and overlapped with the second cushion sheet, and both the first and second cushion sheets continuously and synchronously fed;
a fifth glue providing member configured to roll on a surface of the first cushion sheet facing the second cushion sheet to apply the glue on the surface of the first cushion sheet facing the second cushion sheet, so that a second horizontal glue perpendicular to the feeding direction is applied on the second surface of the first cushion sheet at intervals; or roll on a surface of the second cushion sheet facing the first cushion sheet to apply the glue on the surface of the second cushion sheet facing the first cushion sheet, so that the second horizontal glue perpendicular to the feeding direction is applied on the first surface of the second cushion sheet at intervals, a position of the second horizontal glue opposite to the position of the first horizontal glue of the first cushion sheet or the second cushion sheet;
a bag glue providing member configured to continuously apply a second longitudinal glue to the surface of the first cushion sheet facing the second cushion sheet, and/or the surface of the second cushion sheet facing the first cushion sheet, a position that the bag glue providing member applies the glue is arranged on a side edge of the first cushion sheet or the second cushion sheet along a length direction thereof, and a position of the second longitudinal glue that is continuously applied is continuous along the length direction thereof, the position of the second longitudinal glue opposite to one of the positions of the first longitudinal glue on the first cushion sheet or the second cushion sheet;
at least one group of material pressing rollers arranged at a rear end of the bag glue providing member, the at least one group of material pressing rollers configured to clamp the first cushion sheet and the second cushion sheet, and roll and press the position of the second longitudinal glue after gluing by the bag glue providing member, as well as the position of the second horizontal glue of the first surface or the second surface opposite to each other that are on the first cushion sheet or the second cushion sheet along a direction of perpendicular to the feeding direction, to fix the first cushion sheet and the second cushion sheet; and
a roll-cutting module arranged at a rear end of the at least one group of material pressing rollers and configured to clamp the first cushion sheet and the second cushion sheet that are pressed and fixed, and cut at the positions of the second horizontal glue on the first cushion sheet and the second cushion sheet that are fixed with each other during a rolling process, to form a plurality of packaging bags during the continuous feeding process.

In the packaging bag production device of the present disclosure, simultaneously and continuously feeding the two cushion sheets to the bag glue providing member, and applying the second longitudinal glue to at least one surface of the first and second cushion sheets relative to each other along an edge perpendicular to the feeding direction, to form the position of the second longitudinal glue; at the same time, during the process of producing the cushion sheets by using the cushion sheet production module, the second horizontal glue is applied on the at least one surface of the first and second cushion sheets relative to each other at intervals to form the position of the second horizontal glue, and the position of the second horizontal glue corresponds to the position of the first horizontal glue of the first and second cushion sheets. And then, the position of the second horizontal glue and the position of the second longitudinal glue are rolled and pressed by the material pressing roller to fix the first cushion sheet and the second cushion sheet, and cut at the positions of the second horizontal glue through the roll-cutting module to form a packaging bag thereof.

### BRIEF DESCRIPTION OF THE DRAWINGS

FIG. 1 is a schematic view of a cushion sheet in accordance with an embodiment of the present disclosure.

FIG. 2 is a schematic view of die-cutting and then stretching a third surface to form a buffer layer of the present disclosure.

FIG. 3 is a flow diagram of a cushion sheet production method in accordance with an embodiment of the present disclosure.

FIG. 4 is a schematic view of a process of manufacturing the cushion sheet of the present disclosure.

FIG. 5 is a schematic view of a cutting process of manufacturing the cushion sheet of the present disclosure.

FIG. 6 is a schematic view of a production process of the cushion sheet with two buffer layers.

FIG. 7 is a schematic view of a production process of a cushion sheet in accordance with another embodiment of the present disclosure.

FIG. 8 is a schematic view of the cushion sheet of FIG. 7, shown a first surface of the cushion sheet stacked with a second surface of the cushion sheet.

FIG. 9 is a schematic view of the cushion sheet using buffer layers with other structures of the present disclosure.

FIG. 10 is a schematic view of the cushion sheet production method without a buffer layer of the present disclosure.

FIG. 11 is a flow diagram of a packaging bag production method in accordance with another embodiment of the present disclosure.

FIG. 12 is a schematic view of two cushion sheets with the same depths for manufacturing the packaging bag of the present disclosure.

FIG. 13 is a schematic view of the packaging bag of the present disclosure.

FIG. 14 and FIG. 15 are schematic views of the packaging bag adhered with covers of FIG. 13.

FIG. 16 is similar to FIG. 14, but shown the packaging bag with a cover different from FIG. 14.

FIG. 17 is similar to FIG. 12, but shown the two cushion sheets with different depths thereof.

FIG. 18 and FIG. 19 are schematic views of manufacturing the packaging bag of FIG. 17.

FIG. 20 is a schematic view of a cushion sheet production module in accordance with an embodiment of the present disclosure.

FIG. 21 and FIG. 22 are schematic views of a paper pressing unit of the cushion sheet production module of FIG. 20.

FIG. 23 is a schematic view of a cushion sheet production module for manufacturing the cushion sheet without a buffer layer of the present disclosure.

FIG. 24 is a schematic view of a cushion sheet production module for manufacturing the cushion sheet with two layers of buffer layers of the present disclosure.

FIG. 25 is a schematic view of a cushion sheet production module for directly performing unreeling process on a first surface, a second surface and a third surface of the present disclosure.

FIG. 26 is a schematic view of a cutting roller of the present disclosure.

FIG. 27 is a schematic view of a first glue providing member of the present disclosure.

FIG. 28 is similar to FIG. 27, but shown both the first surface and the second surface glued by the first glue providing member.

FIG. 29 is a schematic view of a cushion sheet production module for manufacturing the cushion sheet by gluing outer surfaces of the cushion sheet of the present disclosure.

FIG. 30 is a partial schematic view of a packaging bag production device of the present disclosure.

FIG. 31 is a schematic view of a roll-cutting module of the present disclosure.

FIG. 32 is a schematic view of a covering paper module and a release paper module of the present disclosure.

FIG. 33 is a schematic view of another packaging bag production device of the present disclosure.

FIG. 34 is a schematic view of the packaging bag production device with a folding module of the present disclosure.

FIG. 35 is a schematic view of a folding structure of the present disclosure.

FIG. 36 is a comparison schematic view of the packaging bag made by the packaging bag production device with the folding structure of the present disclosure.

### DETAILED DESCRIPTION

The present disclosure will be further illustrated and described with reference to embodiments, examples and the accompanying drawings of the specification.

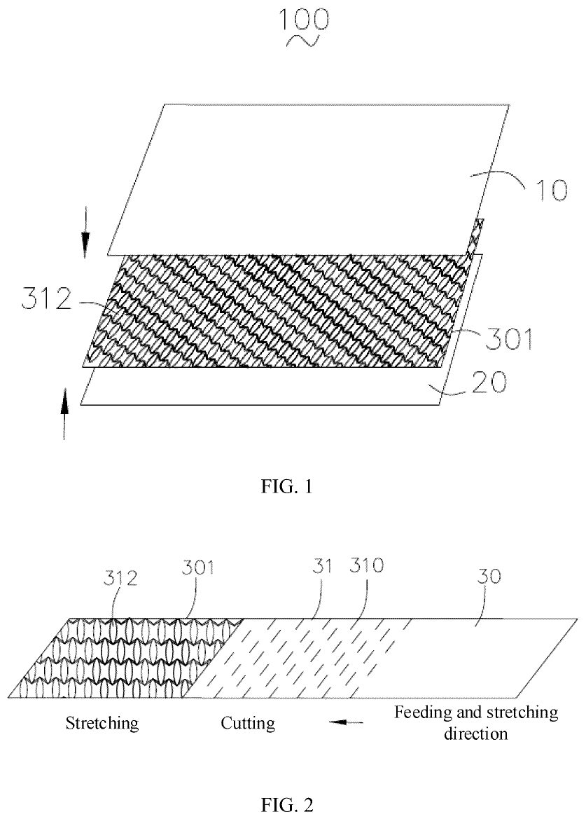

Referring to FIG. 1 and FIG. 2, the present disclosure provides a cushion sheet production method for manufacturing a cushion sheet 100, in the production method, the cushion sheet 100 includes a first surface 10 and a second surface 20, and also can include the first surface 10 and the second surface 20, as well as a buffer layer 301 clamped and fixed between the first surface 10 and the second surface 20.

There are various implementation embodiments of the cushion sheet production method of the present disclosure, which are as follows:
a first embodiment of the present disclosure:
referring to FIG. 2, in an embodiment of the present disclosure, the buffer layer 301 is formed by stretching the third surface 30 after die-cutting the third surface 30. All of the first surface 10, the second surface 20 and the third surface 30 are environmentally friendly paper materials. A plurality of slits 310 is formed on the third surface 30 after die-cutting or cutting the third surface 30. The plurality of slits 310 includes a plurality of rows, the plurality of slits 310 in the same row arranged at intervals, and the plurality of slits 310 in adjacent rows staggered with each other, to form a die-cutting paper 31 thereof. When an external force perpendicular to the plurality of slits 310 is applied to the die-cutting paper 31, the plurality of slits 310 is twisted and deformed into a three-dimensional opening 312. After all the plurality of slits 310 in the plurality of rows are twisted and deformed into three-dimensional openings 312, a buffer layer 301 is formed. The buffer layer 301 is a grid structure, and at this time, a thickness of the buffer layer 301 expands relative to the third surface 30, which can play a buffering and protective role thereof.

Of course, in the present disclosure, after cutting the third surface 30, the thickness of the third surface 30 can be increased by stretching the third surface 30, a cutting way of forming other three-dimensional grid structures can also implement a purpose of the present disclosure.

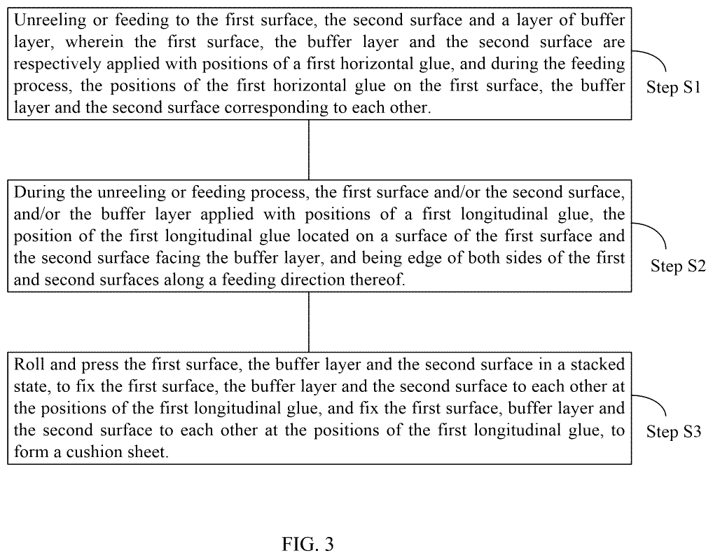

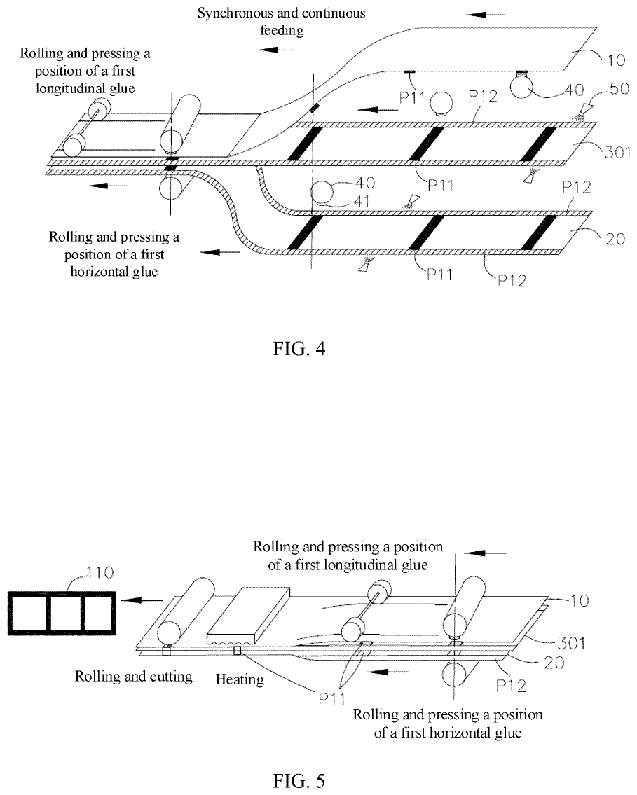

Referring to FIG. 3 and FIG. 4, step S1, unreeling or feeding the first surface 10, the second surface 20 and a layer of buffer layer 301, each of the first surface 10, the buffer layer 301 and the second surface 20 includes a position P11 of a first horizontal glue, the position P11 of the first horizontal glue perpendicular to a feeding direction and arranged at intervals along the feeding direction, with the same spacing distance thereof. During the unreeling or feeding process of the first surface 10, the second surface 20 and the buffer layer 301, the first horizontal glue is rolled and applied to form the position P11 of the first horizontal glue.

Or the first horizontal glue is applied on the position P11 of the first surface 10 and the second surface 20, rather than on the position P11 of the buffer layer 301.

Rolling to sizing glue is referred that a gluing roller 40 is in contact with the first surface 10, the second surface 20 and the buffer layer 301 to apply glue on the first surface 10, the second surface 20 and the buffer layer 301. An outer surface of the gluing roller 40 is equipped with a rolling glue position 41 perpendicular to the feeding direction of a machine and extending from one end of the gluing roller 40 to the other end of the gluing roller 40. The gluing roller 40 is set perpendicular to the feeding direction. When the gluing roller 40 rotates, the gluing roller 40 is only in contact with the position P11 of each of the first surface 10, the second surface 20 or the buffer layer 301, so that glue is applied to the first surface 10, the second surface 20 and the buffer layer 301 respectively. After that, the first horizontal glue is formed on the first surface 10, the second surface 20 and the buffer layer 301.

After applying glue to the position P11, the position P11 of the first surface 10 corresponds to the positions P11 of the buffer layer 301 and the second surface 20 after performing continuous feeding on the first surface 10, the second surface 20 and the buffer layer 301, so as to fix the first surface 10, the buffer layer 301 and the second surface 20 to each other at the positions P11 where the first horizontal glue is applied.

Specifically, there are three gluing rollers 40 arranged, each of the three gluing rollers 40 corresponding to the first surface 10, the second surface 20 and the buffer layer 301. The three gluing rollers 40 arranged in the feeding direction at intervals. After one of the three gluing rollers 40 rolls and applies glue to the first surface 10, when the buffer layer 301 moves below a second gluing roller 40, and the position P11 that has already been glued on the first surface 10 is located below the second gluing roller 40 and opposite to the second gluing roller 40, the second gluing roller 40 then applies glue to the buffer layer 301, which forms a relative relationship between the position P11 of the buffer layer 301 and the position P11 of the first surface 10. Similarly, when a third gluing roller 40 applies glue to the second surface 20, only when both the position P11 of the first surface 10 and the position P11 of the buffer layer 301 move synchronously below the third gluing roller 40, and the third gluing roller 40 applies glue to the second surface 20. There is an inherent setting principle in the setting of three gluing rollers 40, and it is preferred that a distance between two adjacent gluing rollers 40 in the three gluing rollers 40 is an integer multiple of a distance between adjacent positions P11 of the first horizontal glue on the first surface 10, and a circumference distance that each gluing roller 40 rotates one cycle is precisely set to a distance between adjacent positions P11 of the first horizontal glue. Each rotation of the gluing roller 40 corresponds exactly to a sizing glue distance of performing continuous feeding on the first surface 10, the second surface 20 and the buffer layer 301, which is the distance between adjacent positions P11 of the first horizontal glue.

In addition, in the step S1, a first longitudinal glue is arranged on each of the first surface 10 and the second surface 20. The first longitudinal glue is located at a position P12, the position of the first longitudinal glue located on a surface of each of the first surface 10 and the second surface 20 facing the buffer layer 301. The position P12 of the first longitudinal glue is edges on both sides of the first surface 10 and the second surface 20 along the feeding direction.

When the first longitudinal glue is continuously applied, that is, by spraying glue or applying glue, such as a nozzle 50 is used for continuously spraying on both sides of the first surface 10 and the second surface 20 along the feeding direction, to form a strip-shaped area on each of the first surface 10 and the second surface 20, which is also the position P12 of the first longitudinal glue.

Of course, it is also possible to continue applying glue on the buffer layer 301, continuously spraying the first longitudinal glue at the position P12 of the buffer layer 301 along both sides of the feeding direction, so as to better fix the first surface 10, the buffer layer 301 and the second surface 20 to each other at the positions P12 of the first longitudinal glue.

In the present disclosure, both continuous sizing glue and rolling gluing actions are completed during the continuous and synchronous feeding process of the first surface 10, the buffer layer 301 and the second surface 20. On the one hand, compared with the conventional step-by-step feeding method, the present disclosure can save a working time, rather than requiring waiting for a gluing time, on the other hand, the first surface 10, the second surface 20 and the buffer layer 301 can be fixed shortly after being glued, which can ensure a fixed strength thereof.

Of course, in other embodiments of the present disclosure, the first surface 10, the second surface 20 and the buffer layer 301 or the third surface 30 can also be applied with the first horizontal glue and the first longitudinal glue in advance, to respectively form the position P11 of the first horizontal glue and the position P12 of the first longitudinal glue. Then, the first surface 10, the second surface 20 and the buffer layer 301 can be simultaneously unreeled, it is ensured that the positions P11 of the first horizontal glue on the first surface 10, the second surface 20 and the buffer layer 301 are relative to each other, and the positions P12 of the first longitudinal glue are also relative to each other during the unreeling process.

The machine can be referred to FIG. 2 and FIG. 4, in an embodiment of the present disclosure, a formation of the buffer layer 301 includes:

step S11, performing unreeling on the third surface 30 and cutting a plurality of slits 310 arranged on the third surface 30 during performing unreeling on the third surface 30, the plurality of slits 310 including a plurality of rows, the plurality of slits 310 in the same row arranged at intervals, and the plurality of slits 310 in adjacent rows staggered with each other, to form a die-cutting paper 31 thereof; and
step S12, continuously feeding the die-cutting paper 31, and adjusting a feeding speed at a back end to be greater than a feeding speed at a front end along the feeding direction, so that the die-cutting paper 31 is stretched to form the buffer layer 301 with a three-dimensional grid structure.
Step S2, rolling and pressing the first surface 10, the buffer layer 301 and the second surface 20 that are stacked after applying the first horizontal glue and the first longitudinal glue, to fix the first surface 10, the buffer layer 301 and the second surface 20 to each other at the positions P11 of the first horizontal glue and at the positions P12 of the first longitudinal glue to form a cushion sheet thereof.

In the first embodiment of the present disclosure, when rolling and pressing the first surface 10, the buffer layer 301 and the second surface 20 in a stacked state, only the first surface 10, the buffer layer 301 and the second surface 20 are pressed at the positions P11 of the first horizontal glue and the positions P12 of the first longitudinal glue.

In the first embodiment of the present disclosure, only rolling and pressing the positions P11 of the first horizontal glue and the positions P12 of the first longitudinal glue can ensure that the buffer layer 301 between two adjacent positions P11 of the first horizontal glue remains in a three-dimensional grid structure before being pressed, thereby playing a buffering and protective role thereof, preventing the three-dimensional grid structure that has been expanded from being squeezed after the buffer layer 301 is pressed, to reduce the buffering effect thereof.

In addition, after the position P11 of the first horizontal glue and the position P12 of the first longitudinal glue are pressed, the first surface 10, the buffer layer 301 and the second surface 20 cooperatively form a structure similar to a four-side closed and a three-dimensional grid state inside the four sides of the buffer layer 301 that is fixed and clamped by the first surface 10 and the second surface 20, such structure can wrap around surfaces of an article to provide cushioning and shock absorption. In addition, it can also play a role in insulation. Specifically, because the cushion sheet is produced in a non-vacuum environment, after the four sides are sealed, some air will inevitably be filled inside the four sides. Both the first surface 10 and the second surface 20 are made of a paper material, which has low heat absorption and thermal conductivity, in this way, heat is not easily transmitted to an enclosed area between the first surface 10 and the second surface 20, and the air inside the enclosed area can also play a good insulation effect.

In the first embodiment of the present disclosure, a width of the buffer layer 301 perpendicular to the feeding direction is the same as a width of the first surface 10 or the second surface 20. When the position P12 of the first longitudinal glue on the first surface 10 is fixed and pressed with the position P12 of the first longitudinal glue on the buffer layer 301 and/or the second surface 20, the buffer layer 301 at the position P12 is flattened into a planar structure. That is, the buffer layer 301 at the position P12 is a planar grid structure, the buffer layer 301 that is pressed as a planar grid structure, the first surface 10 and the second surface 20 are fixed together. A contact area between the buffer layer 301 of the planar structure and the first surface 10 and the second surface 20 increases, so that a fixing strength also increases accordingly.

Referring to FIG. 5, the method of the embodiment of the present disclosure further includes:
step S3, heating the cushion sheet that is formed at the same time of feeding to ensure that the positions P11 of the first horizontal glue and the positions P12 of the first longitudinal glue are firmly fixed after being pressed together.
step S4, rolling and cutting the cushion sheet at the positions P11 of at least two adjacent or spaced the first horizontal glues to form a buffer unit 110 that is configured to wrap and protect articles and insulate the articles from heat. The buffer unit 110 of the present disclosure can be set in lengths as needed, such as cutting at the positions P11 of two spaced first horizontal glues to form the buffer unit 110 with three glue spacing lengths, or cutting at the positions P11 separated by four first horizontal glues to form the buffer unit 110 with five glue spacing lengths.

During the production process of the cushion sheet of the present disclosure, continuous feeding is used to feed the first surface 10, the second surface 20 and the third surface 30. The first horizontal glue and the first longitudinal glue are applied to the first surface 10, the second surface 20 and the third surface 30, while ensuring continuous feeding without stopping feeding, especially by using rolling and continuous sizing glue. In addition, during the continuous feeding process, rolling pressing is used to fix the first surface 10, the second surface 20 and the buffer layer 301 at the positions P11 of the first horizontal glue and the positions P12 of the longitudinal glue, thereby perfectly fitting the continuous feeding; moreover, rolling cutting is also used for cutting at the positions P11 on the back end thereof, and a cutting interval of performing rolling cutting is precisely set to at least one glue application interval, which can ensure that each rolling can implement one cutting at the positions P11 of the first horizontal glue.

In the first embodiment of the present disclosure, the buffer layer 312 can also be a slit structure of other shapes, such as a triangle or a quadrilateral, or a combination of triangles, quadrilaterals and curves. As long as it is cut on the third surface 30 and stretched to expand the third surface 30 in the thickness direction thereof, a structure with a buffering function is sufficient.

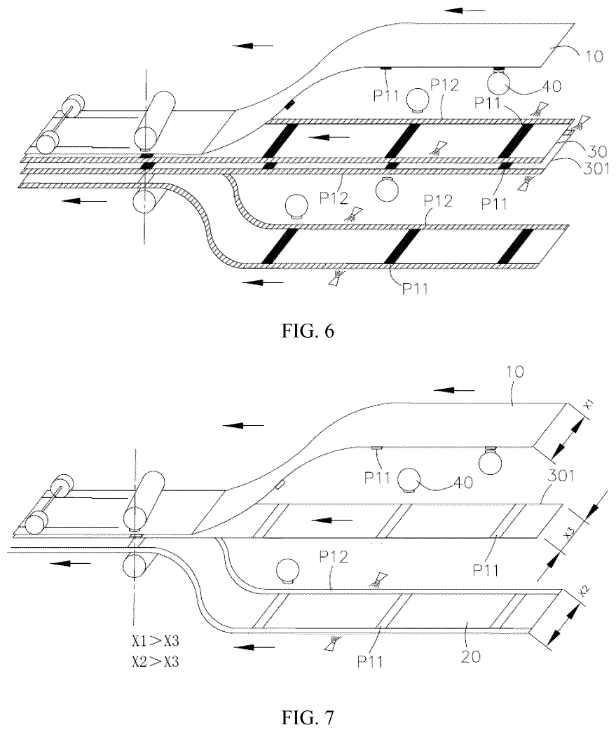

A second embodiment of the present disclosure:
referring to FIG. 6, a difference between the second embodiment and the first embodiment is that the buffer layer 301 that is performed unreeling or feeding has two layers, and of course, more layers of buffer layer 301 can also be set up.

When there are two layers of buffer layers 301, compared to the first embodiment, in the second embodiment of the present disclosure, when rolling and applying the first horizontal glue to the first surface 10, the second surface 20 and the buffer layer 301, an additional gluing roller 40 needs to be added. When adding the gluing roller 40, it is necessary to ensure that two layers of buffer layer 301 can apply the first horizontal glue to positions relative to the position P11 of the first surface 10. The position P11 of the first horizontal glue after rolling and applying the two layers of buffer layer 301 is also relative to each other, and also relative to the position P11 of the first horizontal glue on the second surface 20.

In addition, when continuously applying the first longitudinal glue to the first surface 10 and the second surface 20, it is necessary to apply the first longitudinal glue to the two layers of buffer layers 301 to form the position P12 of the first longitudinal glue. The position P12 of the first longitudinal glue on the two layers of buffer layers 301 is located on both sides along the feeding direction. The position P12 of the first longitudinal glue on the two layers of buffer layers 301 is opposite to the position P12 of the first longitudinal glue on the first surface 10 and the second surface 20.

A third embodiment of the present disclosure:

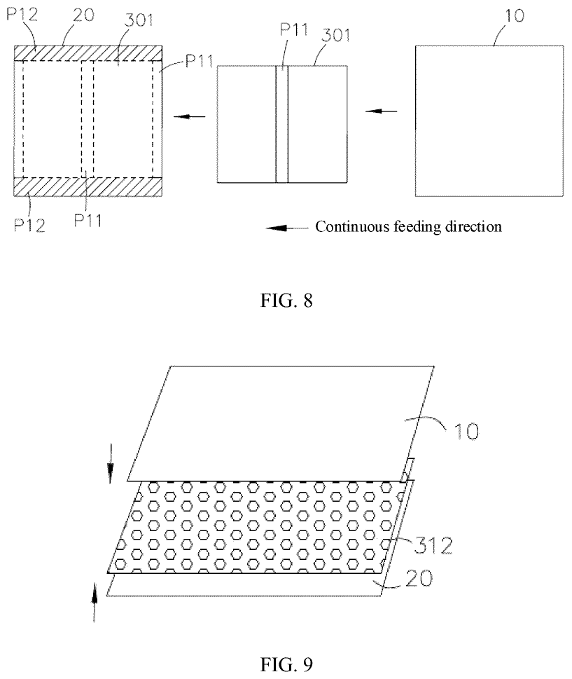

Referring to FIG. 7 and FIG. 8, a difference between the third embodiment and the first embodiment is that a width X3 of the buffer layer 301 perpendicular to the feeding direction is smaller than widths X1 and X2 of the first surface 10 and the second surface 20 perpendicular to the feeding direction, both the width X1 of the first surface 10 and the width X2 of the second surface 20 perpendicular to the feeding direction are the same. The first surface 10 and the second surface 20 extend out of the buffer layer 301 on both sides of their respective width perpendicular to the feeding direction, and the first surface 10 and the second surface 20 completely cover the buffer layer 301; the first surface 10 and the second surface 20 are fixed to each other at the position P12 of the first longitudinal glue to clamp the buffer layer 301 between the first surface 10 and the second surface 20.

In the third embodiment of the present disclosure, the first longitudinal glue does not need to be applied on the buffer layer 301. The position P12 of the first longitudinal glue applied on the first surface 10 and the second surface 20 is located at two side ends that the first surface 10 or the second surface 20 extends out of the buffer layer 301. When the first surface 10 and the second surface 20 are fixed at the positions P12 of the first longitudinal glue, the buffer layer 301 is wrapped inside by the first surface 10 and the second surface 20; at this time, the position P11 of the first horizontal glue set on the buffer layer 301 remains opposite to the position P11 of the first horizontal glue on the first surface 10 and the second surface 20.

Compared to the first embodiment, in the third embodiment of the present disclosure, a step of applying the first longitudinal glue to the buffer layer 301 of the three-dimensional grid structure is reduced, which is beneficial for improving production efficiency thereof.

Regarding the rolling sizing glue and the continuous sizing glue in the first embodiment to the third embodiment of the present disclosure above mentioned, it should be noted that during gluing, it is only necessary to apply glue to at least one surface of two adjacent opposite surfaces in the first surface 10, at least one layer of buffer layer 301 and the second surface 20, or to improve the fixing strength, glue can be applied to two adjacent surfaces.

For example, when the first surface 10, one layer of buffer layer 301, and the second surface 20 are stacked and continuously fed, the first horizontal glue and the first longitudinal glue can be applied on a surface of the first surface 10 facing the buffer layer 301, and at the same time, the first horizontal glue and the first longitudinal glue can be applied on a surface of the second surface 20 facing the buffer layer 301. At this point, when the first surface 10, the buffer layer 301 and the second surface 20 are pressed together, the first horizontal glue and the first longitudinal glue on the first surface 10 are fixed to the buffer layer 301, while the first horizontal glue and the first longitudinal glue on the second surface 20 are also fixed to the buffer layer 301, so that the first surface 10, the second surface 20 and the buffer layer 301 are fixed together.

For example, when the first surface 10, one layer of buffer layer 301, and the second surface 20 are stacked and continuously fed, the first horizontal glue and the first longitudinal glue can be applied on a surface of the first surface 10 facing the buffer layer 301, and at the same time, the first horizontal glue and the first longitudinal glue can be applied on a surface of the second surface 20 facing the buffer layer 301. At this point, when the first surface 10, the buffer layer 301 and the second surface 20 are pressed together, the first horizontal glue and the first longitudinal glue on the first surface 10 are fixed to the buffer layer 301, while the first horizontal glue and the first longitudinal glue on the second surface 20 are also fixed to the buffer layer 301, so that the first surface 10, the second surface 20 and the buffer layer 301 are fixed together. Such fixation method is more firm.

For example, when the first surface 10, one layer of buffer layer 301, and the second surface 20 are stacked and continuously fed, the width of the buffer layer 301 is smaller than the widths of the first surface 10 and the second surface 20, and two ends of the widths of the first surface 10 and the second surface 20 extend out of the buffer layer 301, the first horizontal glue and the first longitudinal glue can be applied on a surface of the first surface 10 facing the buffer layer 301, and at the same time, the first horizontal glue and the first longitudinal glue can be applied on a surface of the second surface 20 facing the buffer layer 301. The position of the first longitudinal glue is located on an outer side of the width direction of the buffer layer 301 relative to the buffer layer 301. At this point, when the first surface 10, the buffer layer 301 and the second surface 20 are pressed together, the first horizontal glue on the first surface 10 is fixed to the buffer layer 301, and the first horizontal glue on the second surface 20 is also fixed to the buffer layer 301. The first longitudinal glue on the first surface 10 and the first longitudinal glue on the second surface 20 are fixed to each other, and the buffer layer 301 is located between the first surface 10 and the second surface 20.

In summary, the positions of applying the first horizontal glue and the first longitudinal glue on the first surface 10, the buffer layer 301 and the second surface 20 can ensure that the first surface 10, the buffer layer 301 and the second surface 20 can be fixed to each other at the position P11 of the first horizontal glue. The first surface 10 and the second surface 20, or the first surface 10, the buffer layer 301 and the second surface 20 can be fixed to each other at the position P12 of the first longitudinal glue.

A fourth embodiment of the present disclosure:

Referring to FIG. 9, a difference between the fourth embodiment and the first embodiment is only that: the buffer layer 312 is not a three-dimensional grid structure, nor a structure formed by stretching a die-cutting paper.

The buffer layer 312 is selected from any one of a bubble film, a corrugated paper and a honeycomb paper. In the fourth embodiment, when the buffer layer 312 is taken as the cushion sheet, the buffer layer 312 is not necessary to be stretched.

Compared to conventional methods that require to be stretched, the manufacturing process of the fourth embodiment is simpler and more convenient.

A fifth embodiment of the present disclosure:

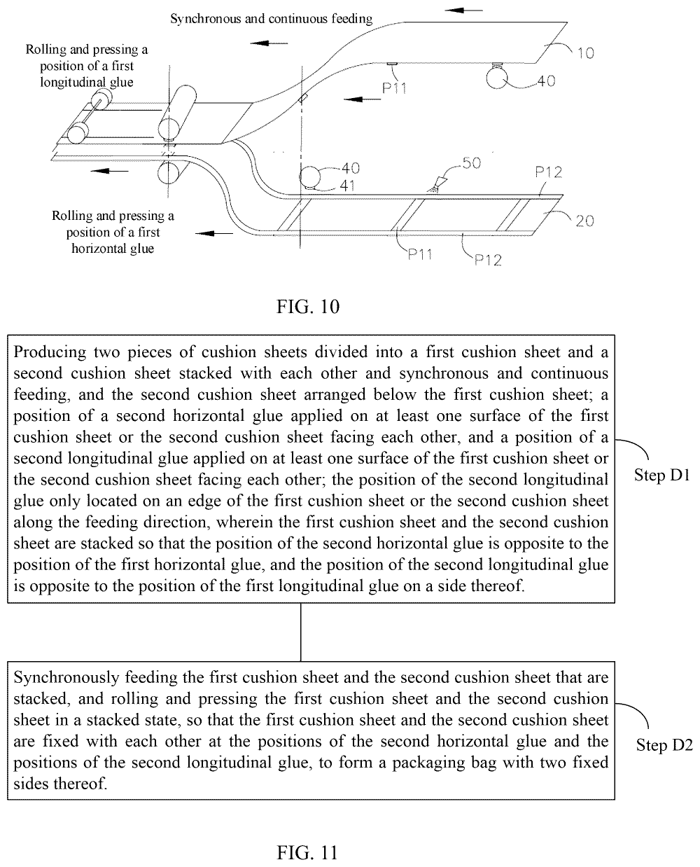

Referring to FIG. 10, specifically, step S1, unreeling or feeding the first surface 10 and the second surface 20, the position P11 of the first horizontal glue is set on the first surface 10 and/or the second surface 20, the position P11 of the first horizontal glue perpendicular to the feeding direction and arranged at intervals along the feeding direction, with the same spacing distance thereof. During the unreeling or feeding process of the first surface 10 or the second surface 20, rolling and sizing glue is applied to the first surface 10 or the second surface 20, to form the position P11 of the first horizontal glue.

After applying glue to the position P11 of the first horizontal glue, the position P11 of the first horizontal glue on the first surface 10 corresponds to the position P11 of the first horizontal glue on the buffer layer 301 and the second surface 20 after performing continuous feeding on the first surface 10, the buffer layer 301 and the second surface 20, so that the first surface 10, the buffer layer 301, and the second surface 20 are fixed at the positions P11 of the first horizontal glue.

Specifically, at least one gluing roller 40 is provided and corresponds to the first surface 10 and/or the second surface 20, respectively. The at least one gluing roller 40 is arranged in the feeding direction at intervals. After one gluing roller 40 rolls and applies glue to the first surface 10, when the buffer layer 301 moves to a second gluing roller 40 and the position P11 of the first horizontal glue that has already been applied on the first surface 10 is located below the second glue roller 40, the second glue roller 40 applies glue to the second surface 20. That is to say, only when the position P11 of the first horizontal glue on the first side 10 moves below the other gluing roller 40, the other gluing roller 40 applies glue to the second surface 20.

In addition, in the step S1, the first surface 10 and/or the second surface 20 are equipped with the position P12 of the first longitudinal glue. The position P12 of the first longitudinal glue is located on a surface of one of the first surface 10 and/or the second surface 20 facing the other of the second surface 20 or the first surface 10. The position P12 of the first longitudinal glue is located on both side edges of the first surface 10 and the second surface 20 along the feeding direction.

In the step S1, the first surface 10 and the second surface 20 are stacked on top and bottom and arranged on the machine to synchronous and continuous feed.
Step S2, rolling and pressing the first surface 10 and the second surface 20 that are stacked with each other after applying the first horizontal glue and the first longitudinal glue, fixing the first surface 10 and the second surface 20 to each other at the positions P11 of the first horizontal glue, and fixing the first surface 10 and the second surface 20 to each other at the positions P12 of the first longitudinal glue to form a cushion sheet.

In the fifth embodiment of the present disclosure, when rolling and pressing the first surface 10 and the second surface 20 in a stacked state, only pressing the first surface 10 and the second surface 20 at the positions P11 of the first horizontal glue and the positions P12 of the first longitudinal glue.

In the fifth embodiment of the present disclosure, when the first surface 10 and the second surface 20 are fixed at the positions P11 of the first horizontal glue and the positions P12 of the first longitudinal glue, some air is sealed between the first surface 10 and the second surface 20, which can play a buffering and protective role to provide insulation and heat preservation.

In the above embodiments of the present disclosure, it should be noted that the first horizontal glue applied on the first surface 10 and the second surface 20 is configured to adhere to the other first surface 10 and the second surface 20 to form glue that can be applied to the cushion sheet 100. The first horizontal glue is arranged perpendicular to the feeding direction at intervals. The first longitudinal glue is also the same to fix the first surface 10 and the second surface 20, but fixed positions are on both sides along the feeding direction, and are arranged continuously with the feeding.

A packaging bag production method according to an embodiment of the present disclosure includes at least two embodiments, specifically:
a sixth embodiment of the present disclosure: referring to FIG. 11 to FIG. 13, the packaging bag production method includes:
step D1, producing two pieces of cushion sheets 101, 102 by using any one of the first embodiment to the fifth embodiment of the present disclosure above mentioned.

The two pieces of cushion sheets 101, 102 are divided to a first cushion sheet 101 and a second cushion sheet 102 stacked with each other, and the second cushion sheet 102 arranged below the first cushion sheet 101; after the first cushion sheet 101 and the second cushion sheet 102 are stacked, the position P11 of the first horizontal glue of the first cushion sheet 101 corresponding to the position P11 of the first horizontal glue of the second cushion sheet 102, and the position P12 of the first longitudinal glue of the first cushion sheet 101 corresponding to the position P12 of the first longitudinal glue of the second cushion sheet 102; and wherein when the first cushion sheet 101 and the second cushion sheet 102 are produced, a position P21 of a second horizontal glue is applied on at least one surface of the first cushion sheet 101 or the second cushion sheet 102 facing each other, and a position P22 of a second longitudinal glue is applied on at least one surface of the first cushion sheet 101 or the second cushion sheet 102 facing each other; the position P22 of the second longitudinal glue only located on an edge of the first cushion sheet 101 or the second cushion sheet 102 along the feeding direction; the first cushion sheet 101 and the second cushion sheet 102 that are stacked so that the position p21 of the second horizontal glue is opposite to the position P11 of the first horizontal glue, and the position P22 of the second longitudinal glue is opposite to the position P12 of the first longitudinal glue on a side thereof.

Step D2, synchronously feeding the first cushion sheet 101 and the second cushion sheet 102 that are stacked, and rolling and pressing the first cushion sheet 101 and the second cushion sheet 102 in a stacked state, so that the first cushion sheet 101 and the second cushion sheet 102 are fixed with each other at the positions P21 of the second horizontal glue and the positions P22 of the second longitudinal glue, to form a packaging bag 200 with two fixed sides and a bottom thereof.

A width of the first cushion sheet 101 along the feeding direction is the same as that of the second cushion sheet 102. When rolling and pressing the first cushion sheet 101 and the second cushion sheet 102 in the stacked state, only the positions P21 of the second horizontal glue and the positions P22 of the second longitudinal glue on the first cushion sheet 101 and the second cushion sheet 102 are pressed.

In the sixth embodiment of the present disclosure, when the first cushion sheet 101 and the second cushion sheet 102 are pressed together at the positions P22 of the second longitudinal glue, the position P22 of the second longitudinal glue is only arranged at one edge of the first cushion sheet 101 or the second cushion sheet 102 along the feeding direction, and no second longitudinal glue is arranged at the other edge of the first cushion sheet 101 or the second cushion sheet 102 along the feeding direction. When the first cushion sheet 101 and the second cushion sheet 102 are pressed and fixed with each other, a structure similar to the packaging bag 200 is formed at the positions P21 of two adjacent second horizontal glue, that is, the positions P22 of the second longitudinal glue along the feeding direction are fixed, and the other edge relative to the positions P22 of the second longitudinal glue is not fixed, thereby forming an opening M between the first cushion sheet 101 and the second cushion sheet 102. The positions P11 of two adjacent horizontal glue are fixed to each other, to be taken as two sides of the opening M, to form a structure with three fixed sides and a side with the opening M.

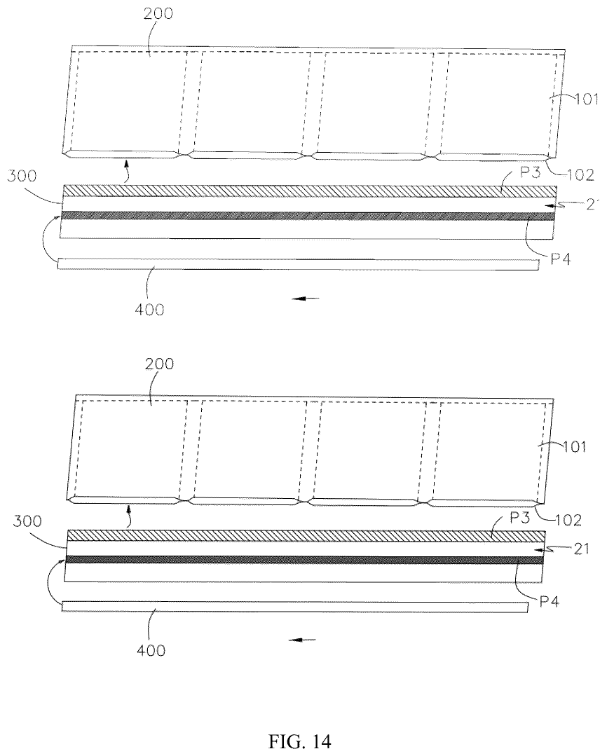

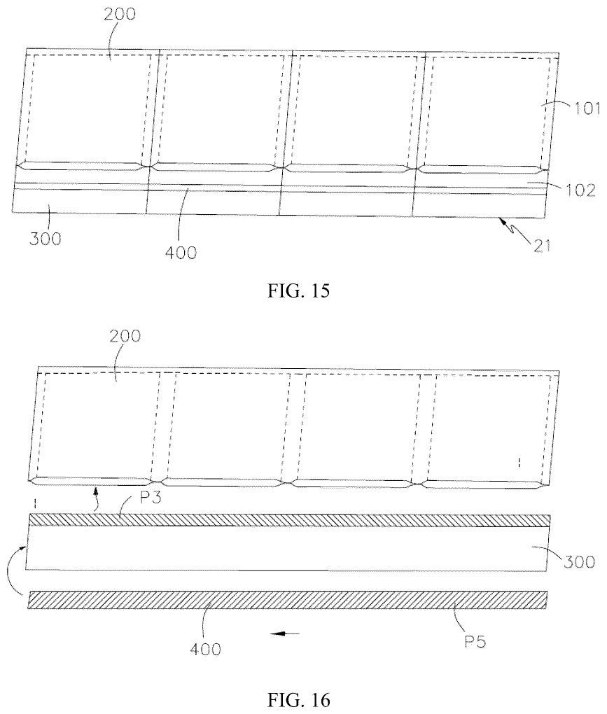

Referring to FIG. 14 and FIG. 15, the packaging bag production method of the present disclosure further includes:
step D3, continuously unreeling a covering paper 300, and applying a third longitudinal glue on edges of the sealing paper 300 along the feeding direction. A position P3 of the third longitudinal glue is continuously arranged along the feeding direction and located on a surface of the covering paper 300 facing the first cushion sheet 101. During the synchronous feeding process of the covering paper 300 and the second cushion sheet 102, the position P3 of the third longitudinal glue is pasted on the second cushion sheet 102, which is located on an opposite edge of the position P22, that is, a side edge of the opening M, so as to form a cover 21.
Step D4, cutting the first cushion sheet 101 and the second cushion sheet 102 that are pressed and fixed with each other, as well as the cover 21 that has been pasted, at the positions P11 of the first horizontal glue or the positions P21 of the second horizontal glue by a rolling and cutting way, to form the packaging bag 200.
Step D5, when continuously unreeling the covering paper 300, applying a fourth longitudinal glue on a middle portion of the covering paper 300 facing the second cushion sheet 102, and positions P4 of the fourth longitudinal glue are continuously arranged along the feeding direction.
Step D6, when continuously performing unreeling on the covering paper 300, synchronously unreeling a release paper 400 and sticking the release paper 400 to the position P4 of the fourth longitudinal glue. Cutting the first cushion sheet 101, the second cushion sheet 102, the cover 21 and the release paper 400 that are pressed and fixed together by using a rolling and cutting way, to form the packaging bag 200.

In the sixth embodiment of the present disclosure, the covering paper 300 is pasted on the outermost side of the second cushion sheet 102 away from the first cushion sheet 101. When the packaging bag 200 that is cut to be formed is in use, folding the cover 21 towards a position of the first cushion sheet 101 and tearing off the release paper 400, and the position P4 of the fourth longitudinal glue is pasted on the first cushion sheet 101, which can seal the opening M formed between the first cushion sheet 101 and the second cushion sheet 102, thereby forming the closed packaging bag 200. In the sixth embodiment of the present disclosure, it should be noted that the second horizontal glue that is applied on the first cushion sheet 101 or the second cushion sheet 102 is configured to adhere to another first cushion sheet 101 or the second cushion sheet 102 to form glue that can be applied to the packaging bag 200. The second horizontal glue is arranged perpendicular to the feeding direction at intervals. And then, the second longitudinal glue is also the same to fix the first cushion sheet 101 and the second cushion sheet 102, but fixed positions are on one side along the feeding direction, and the other side is a reserved opening. After being made into the packaging bag 200, it becomes the opening M of the packaging bag, and the second longitudinal glue is arranged continuously with the feeding.

A seventh embodiment of the present disclosure:

Referring to FIG. 16, a difference between the seventh embodiment and the sixth embodiment is that: bonding and production methods that the covering paper 300 and the release paper 400 are adhered with the second cushion sheet 102 are different.

Specifically, the seventh embodiment of the present disclosure includes steps D1-D4 of the sixth embodiment, and adding a step D7 after the step D4. Step D7: synchronously and continuously unreeling the covering paper 300 and the release paper 400, and when continuously unreeling the release paper 400, applying a fifth longitudinal glue on a surface of the release paper 400 facing the second cushion sheet 102. A position P5 of the fifth longitudinal glue is continuously arranged along the feeding direction; during the reeling process, sticking the position P5 of the fifth longitudinal glue onto the covering paper 300 by facing a direction of the covering paper 300; cutting the first cushion sheet 101, the second cushion sheet 102, the cover 21, and the release paper 400 on the cover 21 by the rolling way, to form the packaging bag 200.

An eighth embodiment of the present disclosure:

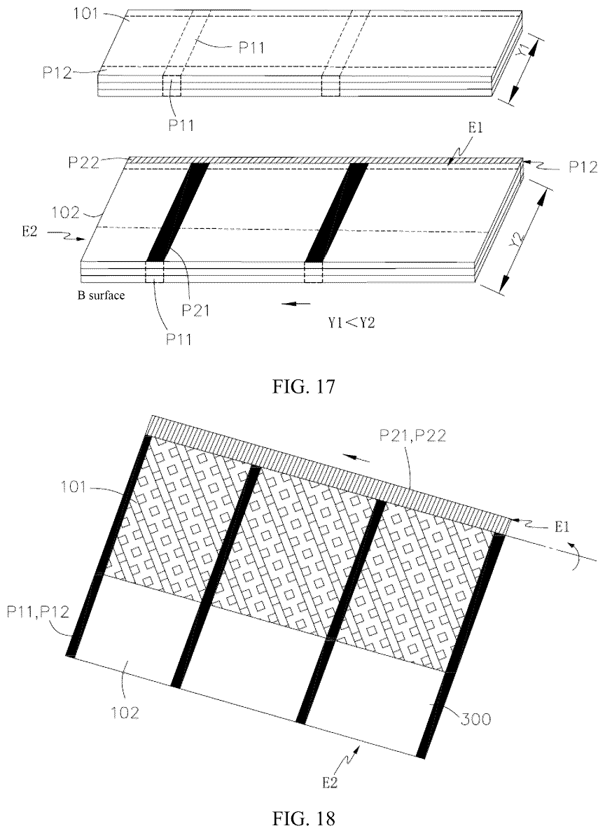

Referring to FIG. 17 to FIG. 19, another packaging bag production method according to the present disclosure includes:
step A1, producing two pieces of cushion sheets 101, 102 by using any one of the first embodiment to the fifth embodiment of the present disclosure above mentioned, the two pieces of cushion sheets 101, 102 are divided to a first cushion sheet 101 and a second cushion sheet 102, the second cushion sheet 102 arranged below the first cushion sheet 101; a width of the first cushion sheet 101 perpendicular to the feeding direction smaller than a width of the second cushion sheet 102 perpendicular to the feeding direction, both sides at the width of the second cushion sheet 102 extending out of the first cushion sheet 101 to form a first edge E1 and a second edge E2, the first cushion sheet 101 and the second cushion sheet 102 stacked to each other and continuously fed.

After the first cushion sheet 101 and the second cushion sheet 102 are stacked, the position P11 of the first horizontal glue of the first cushion sheet 101 corresponds to the position P11 of the first horizontal glue of the second cushion sheet 102, and the position P11 of the first longitudinal glue of the second cushion sheet 102 is located outside the position P12 of the first longitudinal glue of the first cushion sheet 101; and wherein when the first cushion sheet 101 and the second cushion sheet 102 are produced, the position P21 of the second horizontal glue is applied on at least one surface of the first cushion sheet 101 or the second cushion sheet 102 facing each other, the position P21 of the second horizontal glue arranged perpendicular to the feeding direction at intervals; and the position P22 of the second longitudinal glue is applied on a surface of the second cushion sheet 102 facing the first cushion sheet 101; the position P22 of the second longitudinal glue only located on the first edge E1 or the second edge E2 of the second cushion sheet 102 along the feeding direction, wherein the first cushion sheet 101 and the second cushion sheet 102 are stacked so that the position P21 of the second horizontal glue is opposite to the position P11 of the first horizontal glue.
Step A2, synchronously feeding the first cushion sheet 101 and the second cushion sheet 102 that are stacked, and rolling and pressing the first cushion sheet 101 and the second cushion sheet 102 in a stacked state, so that the first cushion sheet 101 and the second cushion sheet 102 are fixed with each other at the position P21 of the second horizontal glue.
Step A3, synchronously feeding the first cushion sheet 101 and the second cushion sheet 102 that are stacked, folding the first edge E1 or the second edge E2 of the second cushion sheet 102 with the position P22 of the second longitudinal glue towards a side of the first cushion sheet 101, rolling and pressing the first edge E1 or the second edge E2 with the position P22 of the second longitudinal glue after folding the first edge E1 or the second edge E2, so that the first cushion sheet 101 and the second cushion sheet 102 are fixed at the position P22 of the second longitudinal glue, to form THE packaging bag 200.

Furthermore, the second longitudinal glue is arranged at the first edge E1, a width of the second edge E2 is greater than a width of the first edge E1, the first edge E1 is folded and fixed with the first cushion sheet 101 to form a bottom of the packaging bag 200, and the second edge E2 forms the cover 21.

Compared to the sixth and seventh embodiments, the eighth embodiment involves pasting positions of the first cushion sheet 101 or the second cushion sheet 102 near the position P22 of the second longitudinal glue onto the other second cushion sheet 102 or the other first cushion sheet 101 by folding the first edge E1 or the second edge E2, to form the bottom of the packaging bag, instead of directly fixing the first cushion sheet 101 and the second cushion sheet 102 at the bottom of the packaging bag, which allows the packaging bag to have a greater depth for receiving articles with larger sizes.

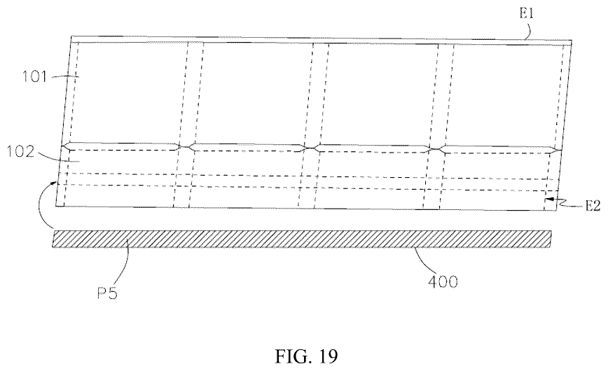

Referring to FIG. 19, the packaging bag production method of the eighth embodiment further includes:
step A4, continuously unreeling the release paper 400, and applying the fifth longitudinal glue on a surface of the release paper 400 facing the second cushion sheet 102 during the unreeling process. A position P5 of the fifth longitudinal glue is continuously arranged along the feeding direction. During the unreeling process, pasting the position P5 of the fifth longitudinal glue onto the second edge E2 towards a direction of the second cushion sheet 102; cutting the first cushion sheet 101, the second cushion sheet 102 and the release paper 400 that are pressed and fixed by using the rolling cutting way, to form the packaging bag.

In the present disclosure, the packaging bags made by the sixth embodiment to the eighth embodiment do not require folding the strip cushion sheet compared to the related art, thus facilitating to produce large-sized packaging bags.

Moreover, the bottom of the packaging bag produced is a fixed structure after sizing glue, resulting in a strong packaging strength thereof.

A cushion sheet production module 500 according to the present disclosure is provided to produce the cushion sheet 100.

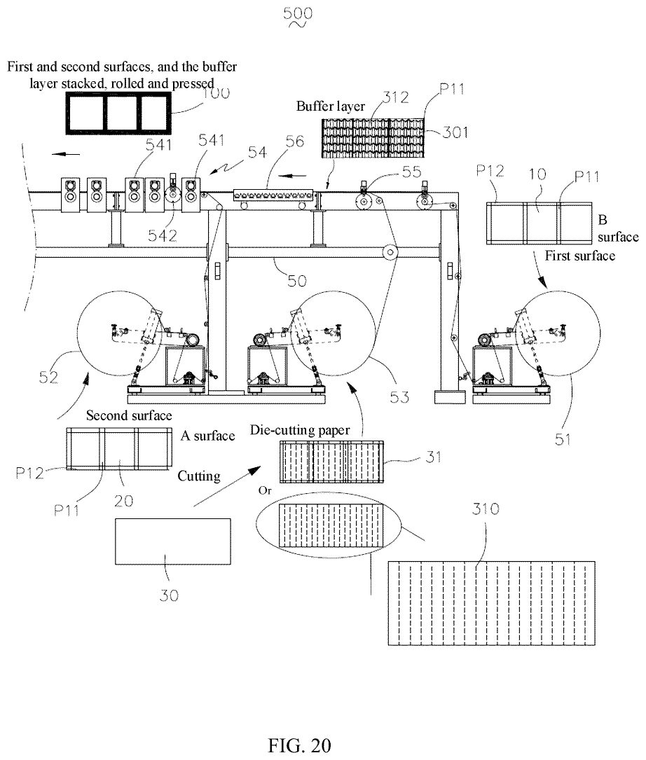

There is a plurality of implementations for the cushion sheet production module. Specific details are as follows:
a ninth embodiment of the present disclosure:
referring to FIG. 20, the cushion sheet production module 500 includes: a first unreeling unit 51, a second unreeling unit 52, a third unreeling unit 53, a paper pressing unit 54 and a pulling roller 55.

The first unreeling unit 51 is arranged on a machine 50 and configured to perform unreeling on the first surface 10 and continuously feed the first surface 10 along a length direction of the machine 50. The third unreeling unit 53 is arranged on the machine 50 and configured to perform unreeling on the die-cutting paper 31. The pulling roller 55 is arranged on the machine 50 and configured to stretch the die-cutting paper 31 to form the buffer layer 301, and continuously feed the buffer layer 301, so that the buffer layer 301 is located below the first surface 10 and synchronously and continuously fed with the first surface 10. A feeding speed of the pulling roller 55 is greater than an unreeling speed of the third unreeling unit 53. The second unreeling unit 52 is arranged on the machine 50 and configured to perform unreeling on the second surface 20, and further configured to synchronously and continuously feed the second surface 20 with the buffer layer 301 along the length direction of the machine 50. The second surface 20 is located below the buffer layer 301.

A plurality of slits 310 is formed on the third surface 30 after die-cutting or cutting the third surface 30. The plurality of slits 310 includes a plurality of rows, the plurality of slits 310 in the same row arranged at intervals, and the plurality of slits 310 in adjacent rows staggered with each other, to form a die-cutting paper 31 thereof. When an external force perpendicular to the plurality of slits 310 is applied to the die-cutting paper 31, the plurality of slits 310 is twisted and deformed into a three-dimensional opening 312. After all the plurality of slits 310 in the plurality of rows are twisted and deformed into three-dimensional openings 312, a buffer layer 301 is formed. The buffer layer 301 is a grid structure, and at this time, a thickness of the buffer layer 301 expands relative to the third surface 30, which can play a buffering and protective role thereof.

In the ninth embodiment of the present disclosure, there is only one third unreeling unit 53 and only one pulling roller 55, and the buffer layer 301 formed that the pulling roller 55 is used to stretch the die-cutting paper 31 also has only one layer.

A fixing glue perpendicular to the feeding direction is applied at intervals on a side that at least one of the first surface 10 and the second surface 20 is opposite to the other of the first surface 10 and the second surface 20, to form the position P11 of the first horizontal glue. The fixing glue is applied continuously on edges of both sides of the first surface 10 and the second surface 20 along the feeding direction, to form the position P12 of the first longitudinal glue.

For a clearer description, in two surfaces of each of the first surface 10, the second surface 20 and the third surface 30, the surface perpendicular to the machine 50 and facing downwards, is defined as a surface B, and the surface perpendicular to the machine 50 and facing upwards is defined as a surface A. Combining with the marked surfaces A and B in the figures, it can be understood the positions P11 and P12 of sizing glue.

The position P11 of the first horizontal glue on the first surface 10 is opposite to the position P11 of the first horizontal glue on the second surface 20 during the feeding process, and the position P12 of the first longitudinal glue on the first surface 10 is opposite to the position P12 of the first longitudinal glue on the second surface 20 during the feeding process.

The first horizontal glue can be applied to the one layer of buffer layer 301, to form the position P11 of the first horizontal glue, and/or applying the first longitudinal glue to form the position P12 of the first longitudinal glue. The first horizontal glue and the first longitudinal glue can also be not applied on the buffer layer 301 with only one layer. When both the first horizontal glue and the first longitudinal glue are applied to the buffer layer 301, the position P11 of the first horizontal glue on the buffer layer 301 corresponds to the position P11 of the first horizontal glue on the first surface 10 and/or the position P11 of the first horizontal glue on the second surface 20, and the position P12 of the first longitudinal glue on the buffer layer 301 corresponds to the position P12 of the first longitudinal glue on the first surface 10 and/or the position P12 of the first longitudinal glue on the second surface 20.

The paper pressing unit 54 is configured to roll, clamp and synchronously feed the first surface 10, the second surface 20 and the buffer layer 301 with the position P11 of the first horizontal glue and the position P12 of the first longitudinal glue, so as to press and fix the first surface 10, the second surface 20 and the buffer layer 301 at the position P11 of the first horizontal glue and the position P12 of the first longitudinal glue, to form the cushion sheet.

In the ninth embodiment of the present disclosure, the buffer layer 301 of the cushion sheet is a three-dimensional grid structure and clamped between the first surface 10 and the second surface 20, except for the position P11 of the first horizontal glue and the position P12 of the first longitudinal glue, thereby achieving the purpose of buffer protection. The buffer layer 301 sandwiched between the first surface 10 and the second surface 20 is enclosed internally by the position P11 of the first horizontal glue and the position P12 of the first longitudinal glue on the first surface 10 and/or the second surface 20, thereby forming a closed space and also providing insulation and thermal insulation thereof.

In the ninth embodiment of the present disclosure, the simplest way is to arrange the position P11 of the first horizontal glue and the position P12 of the first longitudinal glue only on the first surface 10 or the second surface 20. When the first surface 10, the second surface 20 and the buffer layer 301 are superimposed to be fed and pressed, because the buffer layer 301 is a three-dimensional grid structure and has a grid opening 312, the first horizontal glue and the first longitudinal glue on the first surface 10 or the second surface 20 can still be fixed with the buffer layer 301, the first surface 10 or the second surface 20 without the first horizontal glue and the first longitudinal glue through the grid opening 312 of the buffer layer 301.

In the ninth embodiment of the present disclosure, the most firm sizing glue method is that both the positions P11 of the first horizontal glue and the positions P12 of the first longitudinal glue are arranged on the first surface 10, the second surface 20 and the buffer layer 301, and the positions P11 of the first horizontal glue that are on the first surface 10, the second surface 20 and the buffer layer 301 are relative to each other, as well as the positions P12 of the first longitudinal glue.

In the present disclosure, both the position P11 of the first horizontal glue and the position P12 of the first longitudinal glue that are on the first surface 10, the second surface 20 and the buffer layer 301 can be fixed to each other as long as the first surface 10, the second surface 20 and the buffer layer 301 can be fixed to each other.

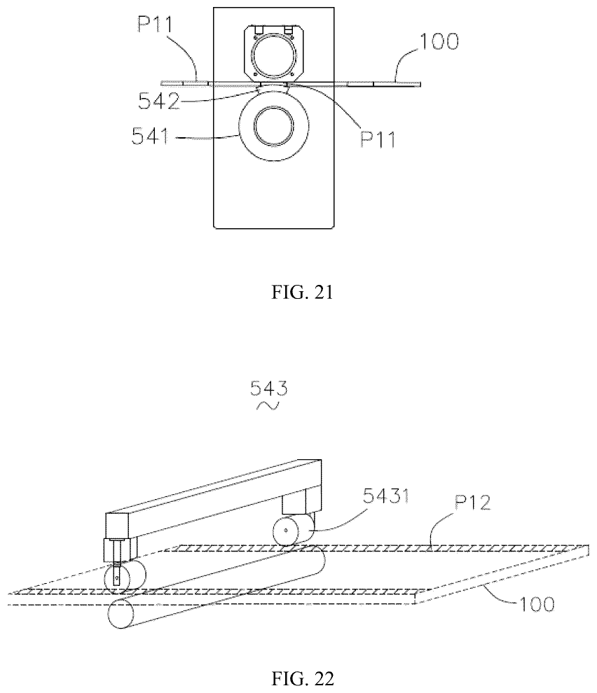

Referring to FIG. 20 and FIG. 21, the paper pressing unit 54 includes at least one group of paper pressing rollers 541, each of the at least one group of paper pressing rollers 541 including a paper pressing bump 542 arranged perpendicular to the feeding direction of the machine 50 and extending from one end of the paper pressing roller 541 towards the other end of the of paper pressing roller 541; when the at least one group of paper pressing rollers 541 rotate, the paper pressing bump 542 is configured to press and fix the first surface 10, the buffer layer 301 and the second surface 20 only at the positions P11 of the first horizontal glue, to ensure that the buffer layer 301 between two adjacent positions P11 of the first horizontal glue is still a three-dimensional grid structure.

Referring to FIG. 21 and FIG. 22, the paper pressing unit 54 further includes at least one group of rotating units 543, each group of rotating units 543 including two rotating rollers 5431 arranged parallel to each other, one rotating roller 5431 arranged above one edge of the first surface 10 and/or the second surface 20 along the feeding direction, and the other rotating roller 5431 arranged above the other edge of the first surface 10 and/or the second surface 20 along the feeding direction; when feeding the first surface 10, the second surface 20 and the buffer layer 301, the rotating roller 5431 pressed on both sides of the first surface 10 or the second surface 20, and relative to the position P12 of the first longitudinal glue, to fix the buffer layer 301, the first surface 10 and the second surface 20 at the positions P12 of the first longitudinal glue during the feeding process.

Referring to FIG. 20, the production module 500 also includes a baking oven 56 arranged on the machine 50 and configured to heat the cushion sheet 100 to make the first surface 10, the second surface 20 and the buffer layer 301 more firmly fixed to each other at the positions P11 of the first horizontal glue and the positions P12 of the first longitudinal glue.

The first surface 10, the second surface 20, and/or the buffer layer 301 that have been heated can make the first surface 10, the second surface 20, and/or the buffer layer 301 more firmly fixed at the positions P11 of the first horizontal glue and the positions P12 of the first vertical glue.

A tenth embodiment of the present disclosure:

A difference between the tenth embodiment and the ninth embodiment is that the cushion sheet material does not have the buffer layer, but is only formed by fixing the first surface 10 and the second surface 20.

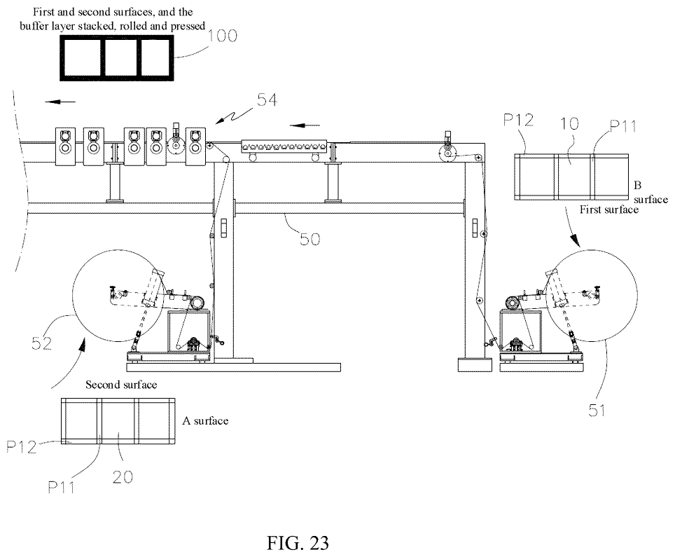

Referring to FIG. 23, the cushion sheet production module 500 includes:
a first unreeling unit 51 arranged on the machine 50 and configured to perform unreeling on the first surface 10 and continuously feed the first surface 10 along a length direction of the machine 50;
a second unreeling unit 52 arranged on the machine 50 and configured to perform unreeling on the second surface 20 and continuously and synchronously feed the second surface 20 with the first surface 10 along the length direction of the machine 50, and the second surface 20 arranged below the first surface 10; the first horizontal glue applied at intervals along a direction perpendicular to the feeding direction and applied on a surface of one of the first surface 10 and/or the second surface 20 facing the other of the first surface 10 or the second surface 20; on the surface of the first surface 10 and/or the second surface 20 facing the other first surface 10 or the other second surface 20, the first longitudinal glue continuously applied along edges of both sides of the feeding direction; the position P11 of the first horizontal glue of the first surface 10 opposite to the position P11 of the first horizontal glue of the second surface 20 during the feeding process, and the position P12 of the first longitudinal glue of the first surface 10 opposite to the position P12 of the first longitudinal glue of the second surface 20 during the feeding process;
a paper pressing unit 54 configured to roll and clamp the position P11 of the first horizontal glue and the position P12 of the first longitudinal glue that are arranged on the first surface 10 and/or the second surface 20, to press and fix the first and second surfaces 10, 20 at the positions P11 of the first horizontal glue and the positions P12 of the first longitudinal glue, to form the cushion sheet 100, wherein gas is sealed between the first surface 10 and the second surface 20 to provide a buffering effect for the cushion sheet 100.

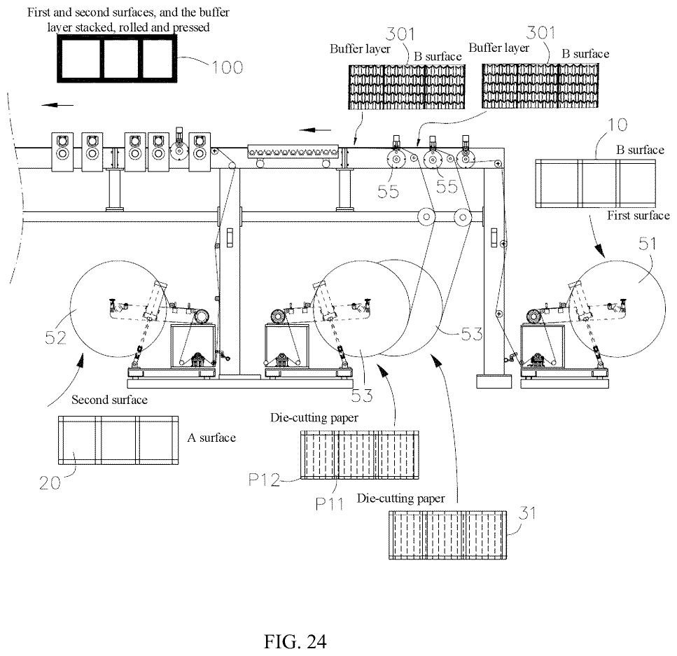

An eleventh embodiment of the present disclosure:
referring to FIG. 24, in the eleventh embodiment of the present disclosure, the production module 500 is used to produce a cushion sheet 100 with no less than two buffer layers 301. A difference between the eleventh embodiment and the ninth embodiment is that there are two third unreeling unit 53 and two pulling rollers 55, and the buffer layer 301 formed by using the pulling roller 55 also has two layers. During the continuous and synchronous unreeling process, the two layers of buffer layers 301 are arranged between the first surface 10 and the second surface 20. When the position P11 of the first horizontal glue and the position P12 of the first longitudinal glue are set on the two layers of buffer layers 301, the position P11 of the first horizontal glue on the two layers of buffer layers 301 corresponds to the position P11 of the first horizontal glue on the first surface 10 and the second surface 20. The position P12 of the first longitudinal glue on the two layers of buffer layers 301 also corresponds to the position P12 of the first longitudinal glue on the first surface 10 and the second surface 20.

One of the two pulling rollers 55 is configured to place the two layers of buffer layers 301 that have been stretched above or below the other of the two pulling rollers 55, and synchronously feed along the feeding direction.

In the eleventh embodiment of the present disclosure, the first horizontal glue and the first longitudinal glue can also be omitted from the two layers of buffer layers 301, as long as the first surface 10, the second surface 20 and the two layers of buffer layers 301 can be fixed at the edges on both sides of the feeding direction and be fixed at intervals perpendicular to the feeding direction.

In the eleventh embodiment of the present disclosure, similarly, the buffer layer 301 can be set three or more layers. At this time, it is only necessary to add the third unreeling unit 53 and the pulling roller 55, and ensure that the plurality of layers of buffer layers 301 that has been stretched is stacked and synchronously fed between the first surface 10 and the second surface 20.

It should be noted that in the ninth embodiment to the eleventh embodiment of the present disclosure, both the first horizontal glue and the first longitudinal glue are applied on the first surface 10, the buffer layer 301 and the second surface 20 is set before the unreeling process or during the unreeling process.

The production module of the present disclosure also includes the following embodiments:
a twelfth embodiment of the present disclosure:
a difference between the twelfth embodiment and the ninth embodiment or the eleventh embodiment is that: the first unreeling unit 51 is configured to perform unreeling on the first surface 10 that has not applied the first horizontal glue and the first longitudinal glue, the second unreeling unit 52 is configured to perform unreeling on the second surface 20 that has not applied the first horizontal glue and the first longitudinal glue, and the third unreeling unit 53 is configured to perform unreeling on the third surface 30 that has not applied the first horizontal glue and the first longitudinal glue, rather than performing unreeling on the die-cutting paper 31.

In the twelfth embodiment of the present disclosure, the production module 500 applies the first horizontal glue and the first longitudinal glue to the first surface 10 and the second surface 20 during the feeding process, thereby forming the position P11 of the first horizontal glue and the position P12 of the first longitudinal glue. During the unreeling process of the third surface 30, the third surface 30 is cut to form the die-cutting paper 31, which is stretched to form the buffer layer 301. The buffer layer 301 is synchronously and continuously fed with the first surface 10 and the second surface 20.

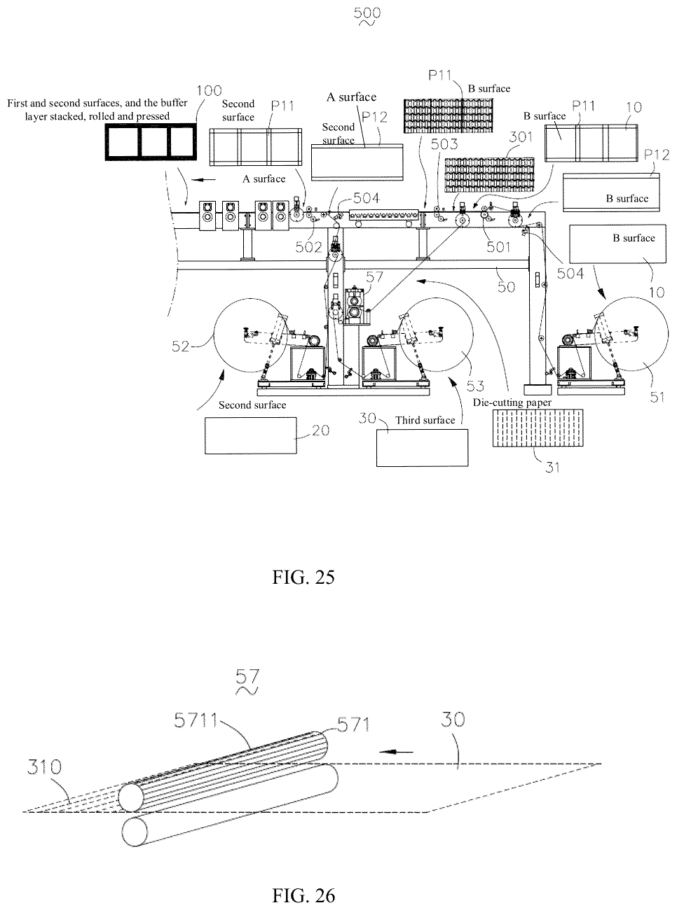

Specifically, referring to FIG. 25 to FIG. 27, the production module further 500 further includes a cutting roller 57 arranged between the third unreeling unit 53 and the pulling roller 55 and configured to cut the third surface 30 into the die-cutting paper 31 during the continuous feeding process. The cutting roller 57 includes rows of cutting knives 571 arranged on an outer surface thereof and extending from one end of the cutting roller 57 to the other end of the cutting roller 57. The same row of cutting knives 571 include a plurality of protrusions 5711 arranged at intervals and configured to cut the die-cutting paper 31 to form a plurality of slits 310, and the protrusions 5711 in two adjacent rows of the cutting knives 571 are arranged in a staggered manner.

A process of feeding the buffer layer 301 is that: the third surface 30 is first performed unreeling by the third unreeling unit 53, then passes through the cutting roller 57. The cutting roller 57 cuts the third surface 30 to form the die-cutting paper 31, which is then stretched by the pulling roller 55 to form the buffer layer 301, and then, the pulling roller 55 sends the buffer layer 301 to the machine 50 and is located below the first surface 10.

The production module 500 further includes a first glue providing member 501, a second glue providing member 502 and a third glue providing member 503 respectively arranged on the machine 50, the first glue providing member 501 arranged on a front end of the pulling roller 55 and configured to roll and clamp the first surface 10, and apply the first horizontal glue on the first surface 10 at intervals along a direction perpendicular to the feeding direction during the continuous feeding process; the second glue providing member 502 arranged on a front end of the paper pressing unit 54 and configured to roll and clamp the second surface 20, and apply the first horizontal glue on the second surface 20 at intervals along a direction perpendicular to the feeding direction during the continuous feeding process; the third glue providing member arranged on a back end of the pulling roller 55 and configured to feed the buffer layer 301 and apply the first horizontal glue on the buffer layer 301 at intervals along a direction perpendicular to the feeding direction during the continuous feeding process, to form the position P11 of the first horizontal glue.

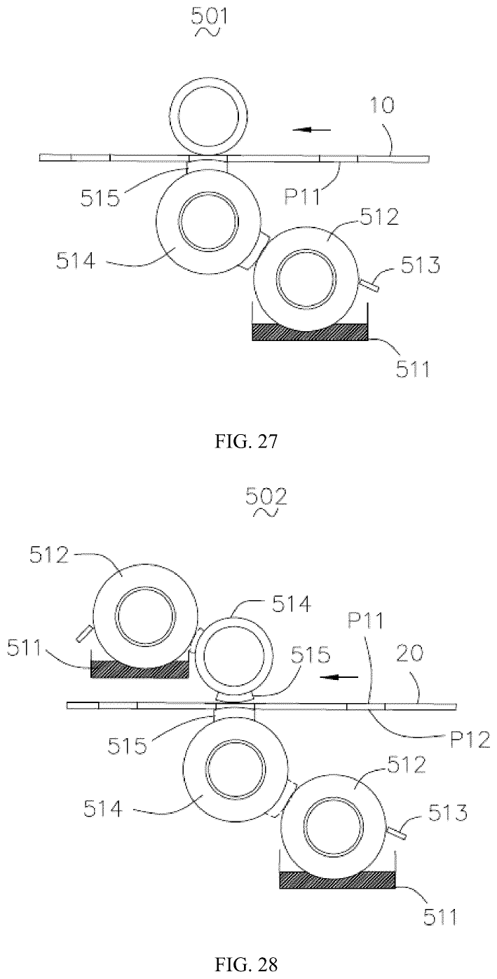

Referring to FIG. 27, the first glue providing member 501, the second glue providing member 502 and the third glue providing member 503 have the same structure. Each of the first glue providing member 501, the second glue providing member 502 and the third glue providing member 503 includes a gluing roller 514, at least one rolling glue position 515 arranged on a peripheral surface of the gluing roller 514, perpendicular to the feeding direction of the machine 50 and extending from one end of the gluing roller 514 to the other end of the gluing roller 514; and wherein when the gluing roller 514 rotates, glues is applied on the first surface 10 and/or the second surface 20 and the buffer layer 301, respectively, only when the rolling glue position 515 is in contact with the first surface 10, the second surface 20 or the buffer layer 301.

Each of the first glue providing member 501, the second glue providing member 502 and the third glue providing member 503 further include a glue tank 511, a glue taking roller 512 and a scraper 513. The glue tank 511 is configured to contain condensed glue, and a portion of a circumference of the glue taking roller 512 is immersed in the glue. A rotation speed of the glue taking roller 512 is not less than that of the gluing roller 514, and the gluing roller 514 rotates synchronously and continuously at the same speed as the feeding speed. And when the gluing roller 514 rotates, the rolling glue position 515 on the gluing roller 514 comes into contact with the circumferential surface of the glue taking roller 512, and then detaches from the outer circumferential surface of the glue taking roller 512 after the rolling glue position 515 has been come into contact with the circumferential surface of the glue taking roller 512. When the rolling glue position 515 is in contact with the circumferential surface of the glue taking roller 512, the glue on the circumferential surface of the glue taking roller 512 is coated on surfaces of the rolling glue position 515; when the gluing roller 514 continues to rotate, the rolling glue position 515 rotates to surfaces of the first surface 10, the second surface 20, or the buffer layer 301 to apply fixed glue to the surfaces of the first surface 10, the second surface 20 or the buffer layer 301, thereby forming the position P11 of the first horizontal glue.

At least one tip of the scraper 513 is arranged near the circumference of the glue taking roller 512. The scraper 513 is configured to scrape off excess glue of the glue taking roller 512, thereby forming a glue layer thereof. A thickness of the glue layer can be adjusted by adjusting a distance between the scraper 513 and the glue taking roller 512.

Referring to FIG. 25, in the twelfth embodiment of the present disclosure, the production module 500 further includes a fourth glue providing member 504 configured to continuously apply fixed glue on the first surface 10 and/or the second surface 20, or the buffer layer 301 along edges of both sides of the feeding direction, thereby forming the position P12 of the first longitudinal glue.

In the twelfth embodiment of the present disclosure, there can be a plurality of fourth glue providing members 504 arranged according to the position P12 of the first longitudinal glue to be set on the first surface 10, the second surface 20, and/or the buffer layer 301. For example, as shown in FIG. 25, two fourth glue providing members 504 are provided, and the fourth glue providing member 504 is configured to apply glue by spraying glue or scraping glue. One of the two fourth glue providing members 504 is arranged at a rear end of the first unreeling unit 51 and configured to apply the first horizontal glue to a surface of the first surface 10 facing the buffer layer 301, while the other of the two fourth glue providing members 504 is arranged at a rear end of the second unreeling unit 52 and configured to apply the first horizontal glue to a surface of the second surface 20 facing the buffer layer 301.

In the twelfth embodiment of the present disclosure, it is also possible to add the number of the fourth glue providing member 504, for example, one fourth glue providing member 504 is added to be arranged at the back end of the pulling roller 55, and configured to apply the first horizontal glue to a surface of the buffer layer 301 facing the first surface 10.

In the twelfth embodiment of the present disclosure, there can be a plurality of layers of buffer layers 301. When there is the plurality of layers of buffer layers 301, adding the number of third unreeling units 53 and cutting roller 57s is sufficient. During performing unreeling on the plurality of layers of buffer layers 301, the plurality of layers of buffer layers 301 also needs to meet requirements that the plurality of layers of buffer layers 301 is arranged between the first surface 10 and the second surface 20, and can be synchronously and continuously fed with the first surface 10 and the second surface 20.

Compared to any one of the ninth embodiment to the eleventh embodiment, in the twelfth embodiment of the present disclosure, all the first surface 10, the second surface 20 and the third surface 30 have the same materials, so it can save manpower and material resources during loading the first surface 10, the second surface 20 and the third surface 30, rather than requiring different purchases and preservation.

In addition, Compared to any one of the ninth embodiment to the eleventh embodiment, in the twelfth embodiment of the present disclosure, the sizing glue action that is applied on the first surface 10, the die-cutting paper 31 formed by stretching the third surface 30, and the second surface 20 is operated during their respective unreeling and feeding processes. It is not necessary to load in advance the first surface 10, the second surface 20 and the die-cutting paper 31 that have already applied glue. If the first surface 10, the second surface 20 and the die-cutting paper 31 also need to be wound up and stored, etc., after the first surface 10, the second surface 20 and the die-cutting paper 31 are pre-glued, and then are performed unreeling through the first unreeling unit 51, the second unreeling unit 52 and the third unreeling unit 53, such above process is more complex and costs are increased. The twelfth embodiment of the present disclosure is beneficial for reducing costs.

In addition, a process of cutting the third surface 30 into the die-cutting paper 31 is also implemented during the feeding process, which is more convenient and simple.

For conveniences of subsequent description, the cushion sheet produced by each of the ninth embodiment, the eleventh embodiment and the twelfth embodiment of the present disclosure is taken as the cushion sheet with a first structure.

A thirteenth embodiment of the present disclosure:

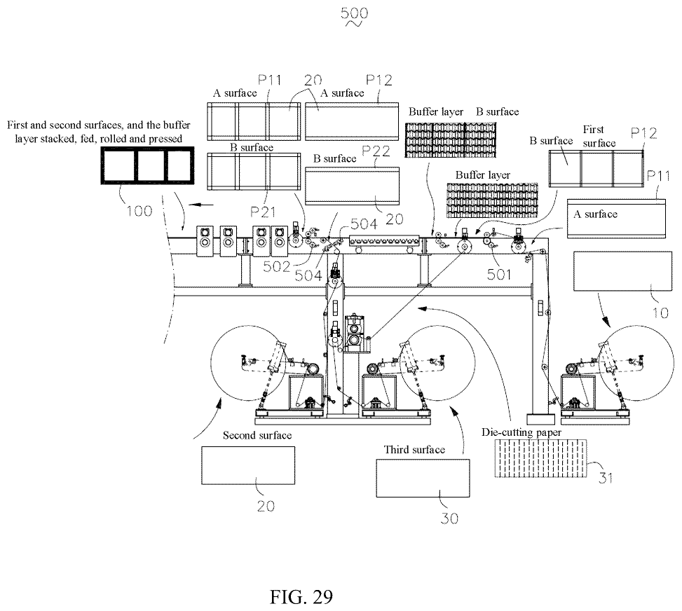

A difference between the cushion sheet production module of the thirteenth embodiment and any one of the ninth embodiment to the twelfth embodiment is that: when producing the cushion sheet, a position P21 of a second horizontal glue and/or a position P22 of a second longitudinal glue are added to be arranged on an outer surface of the first surface 10 of the cushion sheet that is away from the second surface 20, or an outer surface of the second surface 20 that is away from the first surface 10, as shown in FIG. 29.

During producing the cushion sheet of the thirteenth embodiment, a fixing glue perpendicular to the feeding direction is applied to an outer surface of the second surface 20 or the first surface 10 away from the buffer layer 301, thereby forming the position P21 of the second horizontal glue, and the fixed glue is continuously applied along a side edge of the feeding direction, thereby forming the position P22 of the second longitudinal glue; the position P21 of the second horizontal glue corresponds to the position P11 of the first horizontal glue, and the position P22 of the second longitudinal glue corresponds to the position P12 of the first longitudinal glue.

In the thirteenth embodiment of the present disclosure, the position P21 of the second horizontal glue and the position P22 of the second longitudinal glue on the outer surface of the first surface 10 or the second surface 20 away from the buffer layer have been arranged on the first surface 10 or the second surface 20 before performing unreeling on the first surface 10 or the second surface 20, or the glue can be applied to first surface 10 or the second surface 20 during the unreeling process of the first surface 10 or the second surface 20.

When it is applied glue to the outer surface (A surface in the figures) of the first surface 10 or the second surface 20 that is away from the buffer layer during the unreeling or feeding process of the first surface 10 or the second surface 20, the first glue providing member 501 or the second glue providing member 502 adopts a double-sided gluing way to apply glue, as shown in FIG. 28 and FIG. 29. It adds a glue taking roller 512, a gluing roller 514 and a glue tank 511 to be arranged on the outer surface of the first surface 10 or the second surface 20 that is away from the buffer layer 301, and portions of the circumferences of the two glue taking rollers 512 are immersed in the glue, and the two gluing rollers 514 rotate synchronously and continuously, with the same rotation speed as the feeding speed. One of the two gluing rollers 514 applies the fixed glue to one surface of the first surface 10 or the second surface 20, forming the position P21 of the second horizontal glue, while the other of the two gluing rollers 514 applies the fixed adhesive to the other surface of the first surface 10 or the second surface 20, thereby forming the position P21 of the second horizontal glue.

Of course, in the thirteenth embodiment of the present disclosure, two first glue providing members 501 or two second glue providing members 502 can also be set. The two first glue providing members 501 and the two second glue providing members 502 are configured to apply the fixed glue to both sides of the first surface 10 or the second surface 20. The position P21 of the second horizontal glue is arranged on both surfaces of the first surface 10 or the second surface 20.

Referring to FIG. 29, in the thirteenth embodiment of the present disclosure, when it is applied glue to the outer surface of the first surface 10 or the second surface 20 that is away from the buffer layer, to form the second longitudinal glue during the unreeling or feeding process of the first surface 10 or the second surface 20, a fourth glue providing member 504 can be added to be arranged on a side of the outer surface (A surface) of the first surface 10 or the second surface 20 that is away from the buffer layer. That is to say, each fourth glue providing member 504 is set on both sides of the first surface 10 or the second surface 20 in upward and downward directions. The position P22 of the second longitudinal glue is formed on both sides of the first surface 10 or the second surface 20 along the feeding direction through spraying glue or coating glue by the fourth glue providing member 504.

For conveniences of subsequent description, the cushion sheet produced by the thirteenth embodiment of the present disclosure is taken as the cushion sheet with a second structure.

At this point, applicant needs to illustrate that: in the production process of the cushion sheet100 with the first structure and the cushion sheet 100 with the second structure, it is preferred that the width of the buffer layer 301 perpendicular to the feeding direction is less than the width of the first surface 10 and/or the second surface 20 perpendicular to the feeding direction, and the width of the first surface 10 is the same as the width of the second surface 20, and two ends of the width direction of the first surface 10 and the second surface 20 extend out of the buffer layer. In this way, after applying glue to the surface of the first surface 10 and the second surface 20 facing the buffer layer 301 to form the position P12 of the first longitudinal glue, the position P12 of the first longitudinal glue on the first surface 10 or the second surface 20 can be directly fixed with the other of the first surface 10 or the second surface 20, rather than needing to arrange the position P12 of the first longitudinal glue on the buffer layer 301, which can minimize steps and processes of sizing glue and improve production efficiency as much as possible.

A packaging bag production device 600 according to the present disclosure includes a plurality of embodiments as follows:
a fourteenth embodiment of the present disclosure:

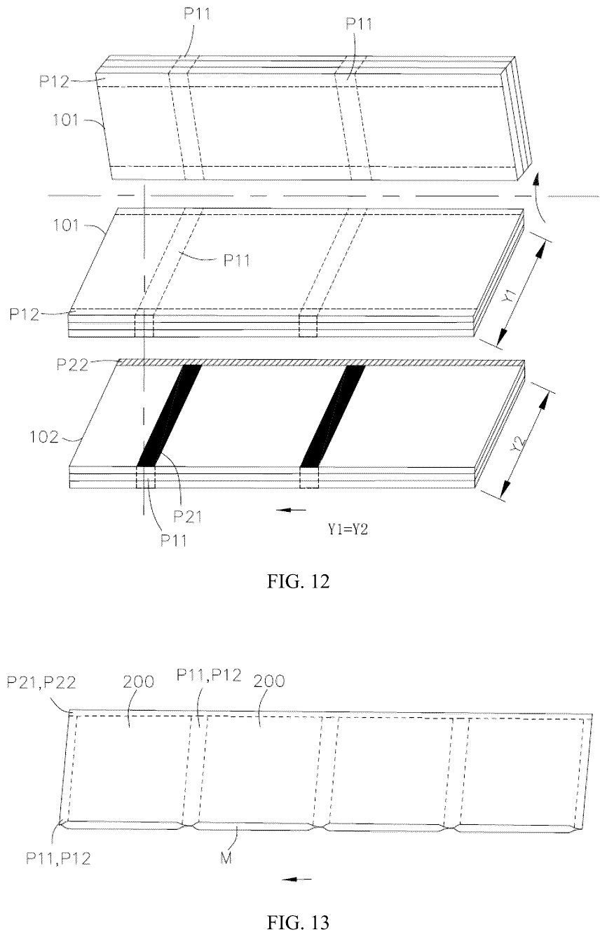

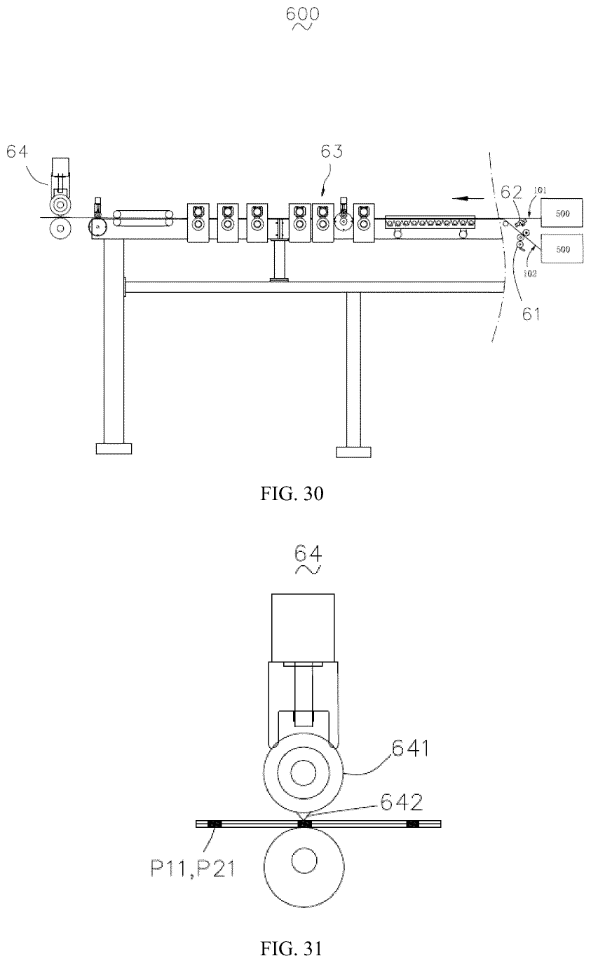

Referring to FIG. 30 and FIG. 31 and combined with FIG. 12, the packaging bag production device 600 includes: two cushion production modules 500, a fifth glue providing member 61, a bag glue providing member 62, at least one group of material pressing rollers 63 and a roll-cutting module 64.

The two cushion sheet production modules 500 are configured to produce two cushion sheets 100 with the first structure, as shown in FIG. 1, that is, the two cushion sheets 100 are not provided the position P21 of the second horizontal glue and the position P22 of the second longitudinal glue on the outer surface (A surface) of the first surface 10 and the second surface 20 that are away from the buffer layer 301.

One of the two cushion sheet production modules 500 is configured to produce a first cushion sheet 101 and the other of the two cushion sheet production modules 500 is configured to produce a second cushion sheet 102, the first cushion sheet 101 arranged above the second cushion sheet 102 and overlapped with the second cushion sheet 102, and both the first cushion sheet 101 and the second cushion sheet 102 continuously and synchronously fed.

The fifth glue providing member 61 is configured to roll on a surface (B surface) of the first cushion sheet 101 facing the second cushion sheet 102 to apply the glue on the surface (B surface) of the first cushion sheet 101 facing the second cushion sheet 102, so that the fixed glue perpendicular to the feeding direction is applied on the surface of the first cushion sheet 101 at intervals, to form the position P21 of the second horizontal glue; or roll on a surface (A surface) of the second cushion sheet 102 facing the first cushion sheet 101 to apply the glue on the surface (A surface) of the second cushion sheet 102 facing the first cushion sheet 101, so that the fixed glue perpendicular to the feeding direction is applied on the surface of the second cushion sheet 102 at intervals, to form the position P21 of the second horizontal glue. The position P21 of the second horizontal glue is opposite to the position P11 of the first horizontal glue of the first cushion sheet 101 or the second cushion sheet 102, and the position P22 of the second longitudinal glue is opposite to one of the positions P12 of the first longitudinal glue of the first cushion sheet 101 or the second cushion sheet 102.

The bag glue providing member 62 is configured to continuously apply the glue to the B surface of the first cushion sheet 101 facing the second cushion sheet 102, and/or the A surface of the second cushion sheet 102 facing the first cushion sheet 101, a position that the bag glue providing member 62 applies the glue is arranged on a side edge of the first cushion sheet 101 or the second cushion sheet 102 along a length direction thereof, the position P22 of the second longitudinal glue is formed after the bag glue providing member 62 applies the glue, and the position P22 of the second longitudinal glue that is continuously applied is continuous along the length direction thereof.

The material pressing roller 63 is arranged at rear ends of the two cushion sheet production modules 500 and the bag glue providing member 62 and configured to clamp the first cushion sheet 101 and the second cushion sheet 102, and roll and press the position P22 of the second longitudinal glue after gluing by the bag glue providing member, as well as the position P21 of the second horizontal glue on the first cushion sheet 101 or the second cushion sheet 102, to fix the first cushion sheet 101 and the second cushion sheet 102. A structure of the material pressing roller 63 is the same or similar to that of the paper pressing unit of the cushion sheet production module 500.

Referring to FIG. 30 and FIG. 31, the roll-cutting module 64 is arranged at the rear end of the material pressing roller 63 and configured to clamp the first cushion sheet 101 and the second cushion sheet 102 that are pressed and fixed, and cut at the position P21 of the second horizontal glue on the first cushion sheet 101 and the second cushion sheet 102 that are fixed with each other during a rolling process, to form a plurality of packaging bags during the continuous feeding process.

The roll-cutting module 64 includes a roll-cutting roller 641 and a roll-cutting knife 642 arranged on the circumferential surface of the roll-cutting roller 641 and perpendicular to an end face of the roll-cutting roller 641. When the roll-cutting roller 641 rotates to the point where the roll-cutting knife 642 comes into contact with the first cushion sheet 101 and the second cushion sheet 102, as the roll-cutting roller 641 rotates, the roll-cutting knife 642 cuts the position P11 of the first horizontal glue perpendicular to the feeding direction and/or the position P21 of the second horizontal glue perpendicular to the feeding direction, thereby forming the packaging bag thereof.

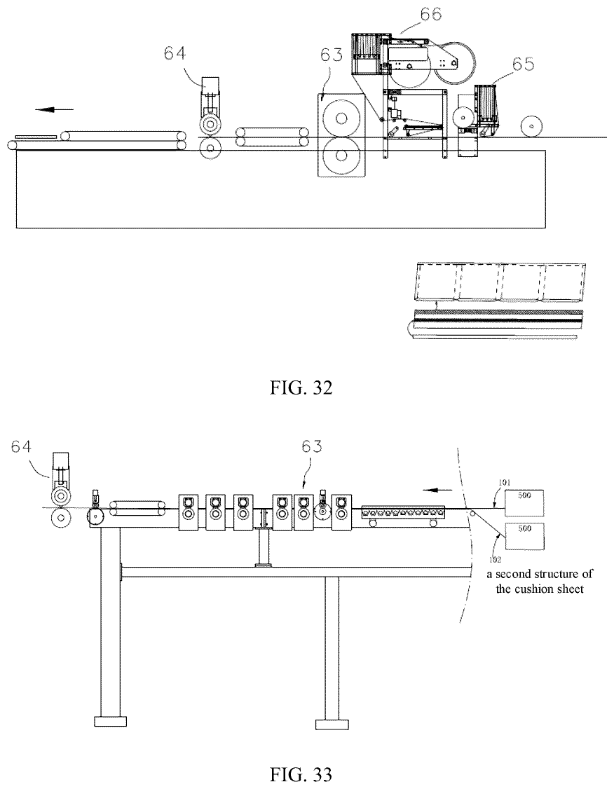

Referring to FIG. 32 and combined with FIG. 14 to FIG. 16, the packaging bag production device 600 further includes a covering paper module 65.

The covering paper module 65 is arranged at a front end of the material pressing roller 63 and configured to perform unreeling on the covering paper 300 and continuously apply glue to the covering paper 300 along the edge of the feeding direction, to form a position P3 of a third longitudinal glue. The position P3 of the third longitudinal glue is arranged on a side of the covering paper 300 facing the first cushion sheet 101. During synchronous feeding the covering paper 300 with the first cushion sheet 101 or the second cushion sheet 102, the position P3 of the third longitudinal glue is pasted on a side of the second cushion sheet 102 away from the position P22 of the second longitudinal glue to form the cover 21.

The packaging bag production device 600 further includes a release paper module 66.

The release paper module 66 is arranged on the front end of the material pressing roller 63. During the continuous unreeling process of the covering paper 300, the release paper module 66 continuously applies the glue to a middle position of the covering paper 300 facing the first cushion sheet101, to form a position P5 of a fourth longitudinal glue. The position P5 of the fourth longitudinal glue is continuous along the feeding direction, and the release paper 400 is synchronously and continuously unreeled, so that the release paper 400 is pasted on the position P5 of the fourth longitudinal glue of the covering paper 300.

When the roll-cutting module 64 cuts the glue position perpendicular to the feeding direction, and synchronously cuts the covering paper 300 and the release paper 400, to form the packaging bag 200 with a cover thereof.

A fifteenth embodiment of the present disclosure:
referring to FIG. 33, a difference between the fifteenth embodiment and the thirteenth embodiment is that: the two cushion sheet production modules 500 are configured to produce at least one cushion sheet 102 with the second structure, and the packaging bag production device does not have the fifth a glue providing member and the bag glue providing member.

At least one of the two cushion sheets is the cushion sheet 102 with the second structure. As the position P21 of the second horizontal glue and the position P22 of the second longitudinal glue have already been pre-set on one outer surface of the cushion sheet 102 with the second structure, the cushion sheet 102 with the second structure and the other cushion sheet 101 can be directly rolled and pressed together, and the cushion sheet 102 with the second structure and the other cushion sheet 101 can be directly fixed to form the packaging bag thereof.

Specifically, at least one cushion sheet 102 is provided with the position P21 for the second horizontal glue and the position P22 for the second longitudinal glue on the outer surface of the first and second surfaces that is away from the buffer layer.

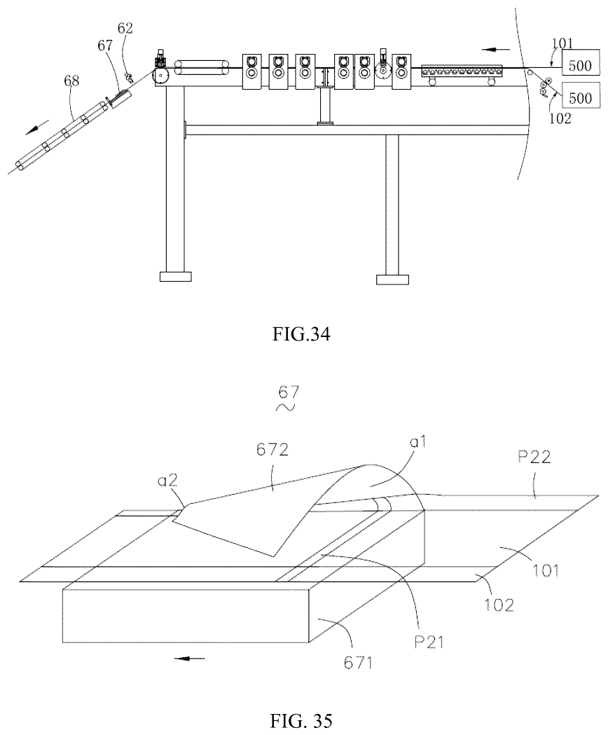

A sixteenth embodiment of the present disclosure:
referring to FIG. 34 and FIGS. 17-18, a difference between the sixteenth embodiment and the thirteenth embodiment is that: a width of the first cushion sheet 101 perpendicular to the feeding direction is smaller than a width of the second cushion sheet 102 perpendicular to the feeding direction, and both sides of the width of the second cushion sheet 102 extend out of the first cushion sheet 101, thereby forming the first edge E1 and the second edge E2.

The position P22 of the second longitudinal glue that is applied by the bag glue providing member 62 is only arranged at the first edge E1 or the second edge E2 of the second cushion sheet 102 along the feeding direction, and both the first edge E1 and the second edge E2 extend out of the first cushion sheet 101. The first edge E1 or the second edge E2 with the position P22 of the second longitudinal glue is a bottom edge of the bag.

In the sixteenth embodiment of the present disclosure, the packaging bag production device 600 further includes a folding module 67 arranged at the rear end of the bag glue providing member 62 and configured to fold the bottom edge of the bag of the second cushion sheet 102 after being continuously applied glue, so that the bottom edge of the bag wraps around opposite edges of the first cushion sheet 101.

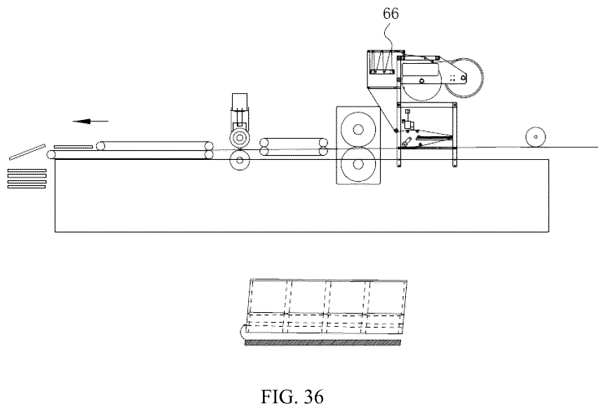

Referring to FIG. 35 and FIG. 36, the folding module 67 includes a platform segment 671 and a curved surface 672 formed by extending from an edge of the platform segment 671. The curved surface 672 has a larger inlet a1 at one end thereof, and a smaller outlet a2 at the other end thereof and parallel to the first cushion sheet 101 and the second cushion sheet 102, wherein a direction of the inlet a1 towards the outlet a2 is the feeding direction. When the first cushion sheet 101 and the second cushion sheet 102 are synchronously and continuously fed into the inlet a1, the first edge E1 or the second edge E2 with the position P22 of the second longitudinal glue is fed on the curved surface 672 and gradually folded under a pressure of the curved surface 672.

In the sixteenth embodiment of the present disclosure, the packaging bag production device 600 further includes a material pressing belt pulley 68 configured to press the bottom edge of the bag that has been folded to fix to the first cushion sheet 101. The first edge E1 or the second edge E2 without the position P22 of the second longitudinal glue is the cover 21, and a width of the cover 21 along a direction perpendicular to the feeding direction is greater than a width of the bottom edge of the bag.

Combined with FIG. 19, the release paper module 66 is arranged at the front end of the material pressing roller 63. During performing unreeling on the release paper 400, the release paper module 66 applies a position P5 of a fifth longitudinal glue on a surface of the release paper 400 facing the second cushion sheet 102. The position P5 of the fifth longitudinal glue is continuously arranged along the feeding direction. During the unreeling process, the position P5 of the fifth longitudinal glue towards a direction of the second cushion sheet is adhered on the first edge E1 or the second edge E2 without the position P22 of the second longitudinal glue, that is, the cover 21. Cutting the first cushion sheet 101, the second cushion sheet 102 and the release paper 400 that are pressed and fixed together by using a rolling cutting mode, to form the packaging bag 200.

What is claimed is:

1. A cushion sheet production method that the cushion sheet comprises a first surface and a second surface, the production method comprising:
step S1, unreeling or feeding the first surface and the second surface, both a first horizontal glue and a first longitudinal glue applied on at least one of the first surface and the second surface, the first horizontal glue and the first longitudinal glue arranged on a surface of the first surface and/or the second surface that faces the other first surface or the other second surface; the first horizontal glue perpendicular to a feeding direction and arranged at intervals along the feeding direction, with the same spacing distance thereof; the first longitudinal glue continuously arranged along edges on both sides of the feeding direction; the first surface and the second surface stacked up and down and arranged on a machine, and synchronously and continuously fed; and wherein
when both the first horizontal glue and the first longitudinal glue are applied on both the first surface and the second surface, the first horizontal glue on the first surface corresponding to the first horizontal glue on the second surface after the first horizontal glue on the first surface is continuously fed, and the first longitudinal glue on the first surface corresponding to the first longitudinal glue on the second surface after the first longitudinal glue on the first surface is continuously fed;
step S2, rolling and pressing the first surface and the second surface that are stacked with each other after applying the first horizontal glue and the first longitudinal glue, with pressing positions only being located at the first horizontal glue and the first longitudinal glue, fixing the first and second surfaces to each other at positions of the first horizontal glue, and fixing the first and second surfaces to each other at positions of the first longitudinal glue to form the cushion sheet; and wherein the cushion sheet is sealed with gas between positions of the first horizontal glue and positions of the first longitudinal glue to provide a buffering effect thereof.

2. The cushion sheet production method as claimed in claim 1, wherein the cushion sheet further comprises at least one layer of buffer layer clamped and fixed between the first surface and the second surface,
when performing unreeling on the first surface and the second surface in the step S1, simultaneously performing unreeling on the at least one layer of buffer layer, and the at least one layer of buffer layer arranged between the first surface and the second surface;
when rolling and pressing the first surface and the second surface in the step S2, the first surface, the at least one layer of buffer layer and the second surface fixed to each other at positions of the first horizontal glue, and the first surface, the at least one layer of buffer layer and the second surface, or the first surface and the second surface fixed to each other at positions of the first longitudinal glue to form the cushion sheet thereof.

3. The cushion sheet production method as claimed in claim 2, wherein at least one surface of the buffer layer facing the first surface or the second surface is applied with the first horizontal glue, during the feeding process, the first horizontal glue on the buffer layer opposite to that of the first surface and/or the second surface, and the first surface, the second surface and the buffer layer rolled and pressed to fix with each other at positions of the first horizontal glue.

4. The cushion sheet production method as claimed in claim 3, wherein the buffer layer has a buffering capacity in a direction perpendicular to the machine, and the buffer layer is any one of a paper three-dimensional grid structure, a bubble film, a corrugated paper and a honeycomb paper.

5. The cushion sheet production method as claimed in claim 4, wherein a width of the buffer layer perpendicular to the feeding direction is smaller than a width of the first surface and/or the second surface perpendicular to the feeding direction, the first surface, the second surface and the buffer layer fixed together by rolling and pressing the positions of the first horizontal glue, both the first surface and the second surface fixed with each other by rolling and pressing the positions of the first longitudinal glue to clamp the buffer layer between the first surface and the second surface.

6. The cushion sheet production method as claimed in claim 5, wherein each of the first surface, the second surface and the buffer layer is made of a paper material, the buffer layer is a three-dimensional grid structure and formed by a third surface, a formation of the buffer layer comprises:
step S11, performing unreeling on the third surface and cutting a plurality of slits arranged on the third surface during performing unreeling on the third surface, the plurality of slits comprising a plurality of rows, the plurality of slits in the same row arranged at intervals, and the plurality of slits in adjacent rows staggered with each other, to form a die-cutting paper thereof; and
step S12, continuously feeding the die-cutting paper, and adjusting a feeding speed at a back end to be greater than a feeding speed at a front end along the feeding direction, the feeding speed of the die-cutting paper entering between the first surface and the second surface greater than a unreeling speed of the die-cutting paper, so that the die-cutting paper is stretched to form the buffer layer; and wherein the buffer layer that has been produced is synchronously and continuously performed unreeling with the first surface and the second surface.

7. The cushion sheet production method as claimed in claim 6, wherein when rolling and pressing the first surface, the buffer layer and the second surface in a stacked state, only the positions of the first horizontal glue and the positions of the first longitudinal glue are pressed.

8. A packaging bag production method comprising:
step A1, producing two pieces of cushion sheets by the method as claimed in claim 1, the two pieces of cushion sheets comprising a first cushion sheet and a second cushion sheet, the second cushion sheet arranged below the first cushion sheet; a width of the first cushion sheet perpendicular to the feeding direction smaller than a width of the second cushion sheet perpendicular to the feeding direction, both sides at the width of the second cushion sheet extending out of the first cushion sheet to form a first edge and a second edge, the first cushion sheet and the second cushion sheet stacked with each other and continuously fed; and wherein after the first cushion sheet and the second cushion sheet are stacked, the position of the first horizontal glue of the first cushion sheet corresponds to the position of the first horizontal glue of the second cushion sheet, and the position of the first longitudinal glue of the second cushion sheet is located outside the position of the first longitudinal glue of the first cushion sheet; and wherein when the first cushion sheet and the second cushion sheet are produced, or after the first cushion sheet and the second cushion sheet are produced and before the first cushion sheet and the second cushion sheet are stacked with each other, a position of a second horizontal glue is applied on at least one surface of the first cushion sheet or the second cushion sheet facing each other, and a position of a second longitudinal glue is applied on a surface of the second cushion sheet facing the first cushion sheet; a position of the second longitudinal glue only located on the first edge or the second edge of the second cushion sheet along the feeding direction, wherein the first cushion sheet and the second cushion sheet are stacked so that the position of the second horizontal glue is opposite to the position of the first horizontal glue;
step A2, synchronously feeding the first cushion sheet and the second cushion sheet that are stacked, and rolling and pressing the first cushion sheet and the second cushion sheet in a stacked state, so that the first cushion sheet and the second cushion sheet are fixed with each other at the position of the second horizontal glue; and
step A3, synchronously feeding the first cushion sheet and the second cushion sheet that are stacked, folding the first edge or the second edge of the second cushion sheet with the position of the second longitudinal glue towards a side of the first cushion sheet, rolling and pressing the first edge or the second edge after folding the first edge or the second edge, so that the first cushion sheet and the second cushion sheet are fixed with each other at the position of the second longitudinal glue, to form a packaging bag thereof.

9. The packaging bag production method as claimed in claim 8, wherein the second longitudinal glue is arranged at the first edge, a width of the second edge is greater than a width of the first edge, and the first edge is folded and fixed with the first cushion sheet to form a bottom of the packaging bag.

10. A cushion sheet production module that a cushion sheet comprises a first surface and a second surface, the cushion sheet production module comprising:
a first unreeling unit arranged on a machine and configured to perform unreeling on the first surface and continuously feed the first surface along a length direction of the machine;
a second unreeling unit arranged on the machine and configured to perform unreeling on the second surface and continuously and synchronously feed the second surface with the first surface along the length direction of the machine, and the second surface arranged below the first surface; a first horizontal glue applied at intervals along a direction perpendicular to the feeding direction and applied on a surface of one of the first surface and/or the second surface facing the other of the first surface or the second surface; on the surface of the first surface and/or the second surface facing the other first surface or the other second surface, a first longitudinal glue continuously applied along edges of both sides of a feeding direction; a position of the first horizontal glue of the first surface opposite to a position of the first horizontal glue of the second surface during the feeding process, and a position of the first longitudinal glue of the first surface opposite to a position of the first longitudinal glue of the second surface during the feeding process; and
a paper pressing unit configured to roll and clamp the position of the first horizontal glue and the position of the first longitudinal glue that are arranged on the first surface and/or the second surface, to press and fix the first and second surfaces at the positions of the first horizontal glue and the positions of the first longitudinal glue, to form the cushion sheet, wherein gas is sealed between the first surface and the second surface to provide a buffering effect for the cushion sheet.

11. The cushion sheet production module as claimed in claim 10, wherein the cushion sheet production module further comprises:
at least one third unreeling unit arranged on the machine and configured to perform unreeling on a buffer layer or the third surface;
at least one pulling roller arranged on the machine and configured to continuously feed the buffer layer or the third surface, wherein the buffer layer is located below the first surface and synchronously and continuously fed with the first surface;
the first horizontal glue applied at intervals on the buffer layer along a direction perpendicular to the feeding direction; the position of the first horizontal glue on the first surface opposite to the position of the first horizontal glue on the second surface during the feeding process; and wherein all the first surface, the second surface and the buffer layer are fixed and pressed against each other at the positions of the first horizontal glue.

12. The cushion sheet production module as claimed in claim 11, wherein the first longitudinal glue is applied on edges of both sides of the buffer layer towards the first surface or the second surface along the feeding direction, and the position of the first longitudinal glue on the first surface and/or the second surface is opposite to the position of the first longitudinal glue on the buffer layer.

13. The cushion sheet production module as claimed in claim 12, wherein the buffer layer is a paper three-dimensional grid structure, and the production module further comprises a cutting roller arranged between the third unreeling unit and the pulling roller, the third unreeling unit configured to perform unreeling on the third surface, the cutting roller configured to cut the third surface into a die-cutting paper during the continuous feeding process, the die-cutting paper stretched to form the buffer layer, and the pulling roller configured to stretch the die-cutting paper that is cut from the third surface.

14. The cushion sheet production module as claimed in claim 13, wherein a second horizontal glue perpendicular to the feeding direction is applied on a surface of the second surface or the first surface that is deviated from the other first surface or the second surface, the second horizontal glue arranged perpendicular to the feeding direction at intervals; a second longitudinal glue continuously applied on a surface of the second surface or the first surface that is deviated from the buffer layer along a side edge of the feeding direction; a position of the second horizontal glue corresponding to the position of the first horizontal glue, and a position of the second longitudinal glue corresponding to one of the positions of the first longitudinal glue.

15. The cushion sheet production module as claimed in claim 14, wherein the production module further comprises a first glue providing member, a second glue providing member and a third glue providing member with the same number of the third unreeling units, respectively arranged on the machine, the first glue providing member configured to roll and clamp the first surface, and apply the first horizontal glue on the first surface at intervals along a direction perpendicular to the feeding direction during the continuous feeding process; the second glue providing member configured to roll and clamp the second surface, and apply the first horizontal glue on the second surface at intervals along a direction perpendicular to the feeding direction during the continuous feeding process; the third glue providing member configured to feed the buffer layer and apply the first horizontal glue on the buffer layer at intervals along a direction perpendicular to the feeding direction during the continuous feeding process; the production module further comprising a fourth glue providing member configured to continuously apply the longitudinal glue on the first surface and/or the second surface, or the buffer layer along edges of both sides of the feeding direction.

16. The cushion sheet production module as claimed in claim 11, wherein the paper pressing unit comprises at least one group of paper pressing rollers, each of the at least one group of paper pressing rollers comprising a paper pressing bump arranged perpendicular to the feeding direction of the machine and extending from one end of the paper pressing roller to the other end of the of paper pressing roller; when the at least one group of paper pressing rollers rotate, the paper pressing bump is configured to press and fix the first surface, the buffer layer and the second surface only at the positions of the first horizontal glue.

17. The cushion sheet production module as claimed in claim 16, wherein the paper pressing unit further comprises at least one group of rotating units, each of the at least one group of rotating units comprising two rotating rollers arranged parallel to each other, one of the two rotating rollers arranged above one edge of the first surface and/or the second surface along the feeding direction, and the other of the two rotating rollers arranged above the other edge of the first surface and/or the second surface along the feeding direction; when feeding the first surface, the second surface and the buffer layer, the rotating roller pressed on both sides of the first surface or the second surface, and relative to the position of the first longitudinal glue, to fix the buffer layer, the first surface and the second surface at the positions of the first longitudinal glue during the feeding process.

18. The cushion sheet production module as claimed in claim 15, wherein each of the first glue providing member, the second glue providing member and the third glue providing member comprises a gluing roller, at least one rolling glue position arranged on a peripheral surface of the gluing roller and perpendicular to the feeding direction of the machine, and extending from one end of the gluing roller to the other end of the gluing roller; and wherein when the gluing roller rotates, glues is applied on the first surface and/or the second surface, and the buffer layer, respectively, only when the rolling glue position is in contact with the first surface, the second surface or the buffer layer.

19. A packaging bag production device comprising:
two cushion sheet production modules as claimed in claim 10, one of the two cushion sheet production modules configured to produce a first cushion sheet and the other of the two cushion sheet production modules configured to produce a second cushion sheet, the first cushion sheet arranged above the second cushion sheet and overlapped with the second cushion sheet, and both the first cushion sheet and the second cushion sheet continuously and synchronously fed;
a fifth glue providing member configured to roll on a surface of the first cushion sheet facing the second cushion sheet to apply the glue on the surface of the first cushion sheet facing the second cushion sheet, so that a second horizontal glue perpendicular to the feeding direction is applied on the second surface of the first cushion sheet at intervals; or roll on a surface of the second cushion sheet facing the first cushion sheet to apply the glue on the surface of the second cushion sheet facing the first cushion sheet, so that the second horizontal glue perpendicular to the feeding direction is applied on the first surface of the second cushion sheet at intervals, a position of the second horizontal glue opposite to the position of the first horizontal glue of the first cushion sheet or the second cushion sheet;
a bag glue providing member configured to continuously apply a second longitudinal glue to the surface of the first cushion sheet facing the second cushion sheet, and/or the surface of the second cushion sheet facing the first cushion sheet, a position that the bag glue providing member applies the glue is arranged on a side edge of the first cushion sheet or the second cushion sheet along a length direction thereof, and a position of the second longitudinal glue that is continuously applied is continuous along the length direction thereof, the position of the second longitudinal glue opposite to one of the positions of the first longitudinal glue on the first cushion sheet or the second cushion sheet;
at least one group of material pressing rollers arranged at a rear end of the bag glue providing member, the at least one group of material pressing rollers configured to clamp the first cushion sheet and the second cushion sheet, and roll and press the position of the second longitudinal glue after gluing by the bag glue providing member, as well as the position of the second horizontal glue of the first surface or the second surface opposite to each other that are on the first cushion sheet or the second cushion sheet along a direction of perpendicular to the feeding direction, to fix the first cushion sheet and the second cushion sheet; and
a roll-cutting module arranged at a rear end of the at least one group of material pressing rollers and configured to clamp the first cushion sheet and the second cushion sheet that are pressed and fixed, and cut at the positions of the second horizontal glue on the first cushion sheet and the second cushion sheet that are fixed with each other during a rolling process, to form a plurality of packaging bags during the continuous feeding process.

20. The packaging bag production device as claimed in claim 19, wherein a width of the first cushion sheet perpendicular to the feeding direction is smaller than a width of the second cushion sheet perpendicular to the feeding direction, both sides of the width of the second cushion sheet extending out of the first cushion sheet, to form a first edge and a second edge;
the position of the second longitudinal glue only located at the first edge or the second edge of the second cushion sheet along the feeding direction, the first and second edges extending out of the first cushion sheet, the first edge or the second edge with the second longitudinal glue formed a bottom edge of a bag;
a folding module arranged at the rear end of the bag glue providing member and configured to fold the bottom edge of the bag of the second cushion sheet after being continuously applied glue, so that the bottom edge of the bag wraps around opposite edges of the first cushion sheet; and
the at least one group of material pressing rollers configured to press the bottom edge of the bag that is folded to fix the bottom edge of the bag on the first cushion sheet.
